(19) United States
(12) Patent Application Publication
(10) Pub. No.: US 2007/0244745 A1
(43) Pub. Date: Oct. 18, 2007

(54) Database management for managing data distribution

(76) Inventor: Steven R. Boal, Los Altos, CA (US)

Correspondence Address: FISH & RICHARDSON P.C., PO BOX 1022, MINNEAPOLIS, MN, 55440-1022, US

(21) Appl. No.: 11/372,243

(22) Filed: Mar. 8, 2006

Related U.S. Application Data
(63) Continuation of application No. 09/451,160, filed on Nov. 30, 1999.
(63) Continuation of application No. 10/439,237, filed on May 16, 2003.

(51) Int. Cl. G06Q 30/00

(52) U.S. Cl. 705/14

(57) ABSTRACT

A system and method of distributing electronic coupon securely are disclosed, which includes a main database system, and a client system interconnected by a distributed computer network. Coupon data and advertising data can be encrypted to reduce the likelihood that such data may be misused, such as by unauthorized duplication. In addition, the client database system can be identified by a user identification that is allocated and associated with the user information collected from the user of the client database system. The user information can be indicative of one or more demographic characteristics of the user without being sufficiently and personally identify the user, thus preserving privacy. An icon can be provided to alert the user that new coupons are available.

### TECHNICAL FIELD

The present invention relates generally to databases, data storage and retrieval.

### BACKGROUND OF THE INVENTION

Every year, several hundred billion coupons are circulated in the United States. Nearly all are distributed using traditional “scatter gun” approaches, such as those included in Sunday circulars and direct mailings. However, consumers waste time clipping coupons that expire, or accumulate for years in undesirable places, such as kitchen drawers. Moreover, such traditional methods of coupon distribution do not effectively reach the ever increasing group of consumers that use public computer networks, such as the World Wide Web portion of the Internet (the “web”).

### SUMMARY OF THE INVENTION

One advantage of a proposed data distribution system and methods is that it ensures the privacy of its users by only collecting user information indicative of demographic characteristics of the user without obtaining information sufficient to specifically identify the user. The system therefore has the needed information to identify coupons appropriate for the user based on such user's demographic characteristics. Another advantage of the proposed system and methods is that it provides secure electronic coupon distribution through encryption of coupon information. Yet another advantage of the proposed system and methods is that it is configured to automatically update a client database system through which the user interacts with new coupon data without any intervention by the user. Still yet another advantage involves the deployment of a visual alert to inform the user of new coupon availability. In particular, a client database system is configured to operate in accordance with an operating system (OS) characterized by a graphical user interface (GUI) wherein the client database system includes an icon displayed in a different state (e.g., “flashing”) when new coupons are available for the user.

These and other features and advantages are realized by a method data distribution system comprising several basic steps. The first step involves collecting user information from a user of a client database system indicative of one or more demographic characteristics of the user without obtaining information sufficient to specifically identify the user. The next step involves associating at a main database system a user ID with the collected user information. The method includes selecting coupons according to the user ID to thereby identify coupons appropriate for the user based on the user's demographic characteristics. Finally, the method includes transmitting the selected coupons from the main database system to the client database system.

In one implementation, the user demographic characteristics include at least one of a postal zip code associated with the user and the state in which the user resides. By avoiding obtaining information sufficient to specifically identify the user, privacy is maintained.

In yet another implementation, coupon data at the main database system is encrypted in accordance with a main database system encryption strategy prior to being sent to the client database system. This step minimizes the chance of coupon fraud. In a further implementation, the encrypted coupon data as received at the client database system is further encrypted in accordance with a client database system encryption strategy to thereby generate doubly encrypted coupon data prior to being stored on the client database system.

In yet a further implementation, the client database system transmits a request to the main database system to provide updated coupon information automatically without any intervention by the remote user to thereby define a “persistent” client having automatic coupon delivery.

Other objects, features, and advantages of the present invention will become apparent to one skilled in the art from the following detailed description and accompanying drawings illustrating features of this invention by way of example, but not by way of limitation.

### BRIEF DESCRIPTION OF THE DRAWINGS

FIG. 1 shows an exemplary data distribution system.

FIG. 2 illustrates exemplary components of a coupon database server.

FIG. 3 illustrates exemplary components of a main database system.

FIG. 4 illustrates exemplary components of a client database system.

FIG. 5A shows an exemplary user interface for distributing coupons between a main database system and a client database system.

FIG. 5B shows an exemplary taskbar icon representative of a GUI executed by a client application.

FIG. 6 is an exemplary flowchart diagram illustrating interactions between a client database system, and a main database system.

FIG. 7 is an exemplary flowchart diagram showing, in greater detail, initial steps as discussed with respect to FIG. 6 for system initialization.

FIG. 8 is an exemplary flowchart showing, in greater detail, an echo request step as discussed with respect to FIG. 7.

FIG. 9 is an exemplary flowchart showing a server selection routine performed by a main database system.

FIG. 10 is an exemplary flowchart showing a process for registration of a new user by a main database system.

FIGS. 11-13 are exemplary flowcharts showing, in greater detail, a process of updating a master category list, plug-ins, and brand logo information, respectively, as discussed with respect to FIG. 6.

FIG. 14 is an exemplary flowchart showing, in greater detail, a step of updating advertising data as discussed with respect to FIG. 6.

FIG. 15 is an exemplary flowchart showing, in greater detail, a step of updating coupon data as discussed with respect to FIG. 6.

FIG. 16 is an exemplary flowchart showing, in greater detail, a step of updating a main database system with a user history file as discussed with respect to FIG. 6.

FIG. 17 is an exemplary flowchart showing a process involved in obtaining a client script.

FIGS. 18-19 are simplified flowcharts showing alternate responses taken by a client database system in response to double-clicking a taskbar icon.

FIG. 20 is an exemplary flowchart showing timing mechanisms for automatically updating coupon data without user intervention.

FIGS. 21-22 are simplified flowcharts showing alternate actions taken by a client database system in response to selection by a user of a logo pane and an advertising pane, respectively.

FIG. 23 is an exemplary flowchart showing a process executed by a client database system when a user selects an item from a coupon subcategory list.

FIG. 24 is an exemplary flowchart showing a process executed by a client database system when a user selects a particular coupon.

FIG. 25 is an exemplary flowchart showing a process executed by a client database system when a coupon is selected and added to a print cart.

FIG. 26 is a block diagram illustrating an exemplary hardware system for supporting a client database system.

### DETAILED DESCRIPTION

Conventional data distribution systems can be used for storing, retrieving and manipulating coupon data. In some implementations, the data distribution system described herein includes internal logic to handle such tasks, and one or more computer programs configured to facilitate the creation, organization and management of databases associated with coupon distribution. For example, the data distribution system can include a coupon database server in which applications programs or servers can send messages and data to the coupon database server in a predefined format for managing coupon distribution. Although these implementations are presented herein in the form of a database distribution system, it should be understood that the teachings herein may be applied more generally to any management system, including or in addition to management systems involving data distribution.

### Data Distribution System Architecture

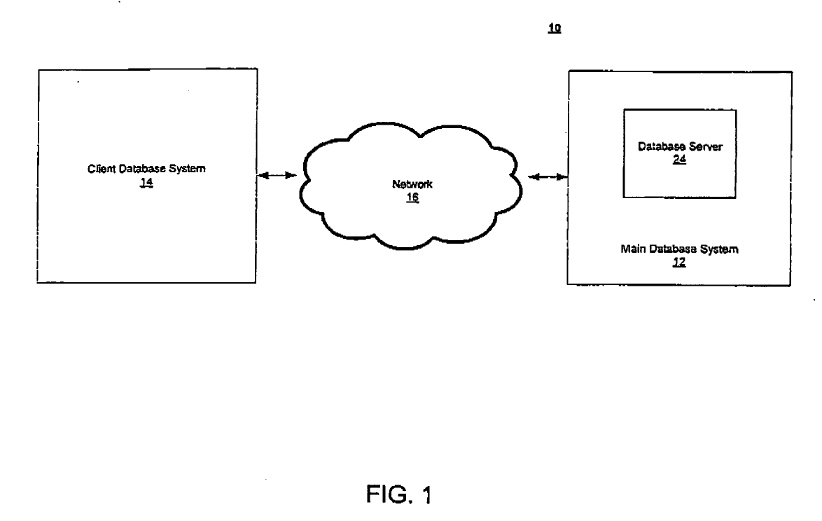

FIG. 1 shows an exemplary data distribution system 10. Referring to FIG. 1, the data distribution system 10 generally includes a main database system 12 and a client database system 14 that is remote from the main database system 12. The main database system 12 and the client database system 14 can be connected together by a distributed computer network 16. The main database system 12 can include various servers such as database servers and application servers. As illustrated, the main database system 12 includes a coupon database server 24, which can be configured to operate using SQL server software, such as Microsoft SQL Server®, commercially available from Microsoft Corporation of Redmond, Wash.

In some implementations, the coupon database server 24 can include one or more physical, individual general purpose computing systems configured as database servers, which can be arranged in a cluster environment, for distributing coupons available in the coupon database server 24. In these implementations, additional computing systems also may be added to provide for load balancing (i.e., scalability, and the ability to quickly add additional hardware as load and responsiveness criteria require).

The client database system 14 can be any system that uses or deploys software. The software can be a single application or an operating system, a collection of software applications or software components that perform various tasks in a larger system or application. The network 16, such as an Internet, can be configured to facilitate continuous or periodic data exchange between the main database system 12 and the client database system 14 using conventional networking protocols (e.g., TCP/IP, HTTP). The networking protocol interfaces can allow the client database system 14 to connect directly to any application within the system 10, or to external applications via the network 16.

In some implementations, the network 16 can provide users with transparent, virtual access to applications, processes, and functions regardless of the physical location of the client database system 14 where applications, processes, and functions reside. For example, a user desiring to obtain electronic coupons can use the client database system 14 to interact with the main database system 12 to obtain electronic coupons, regardless of the physical location of the client database system 14.

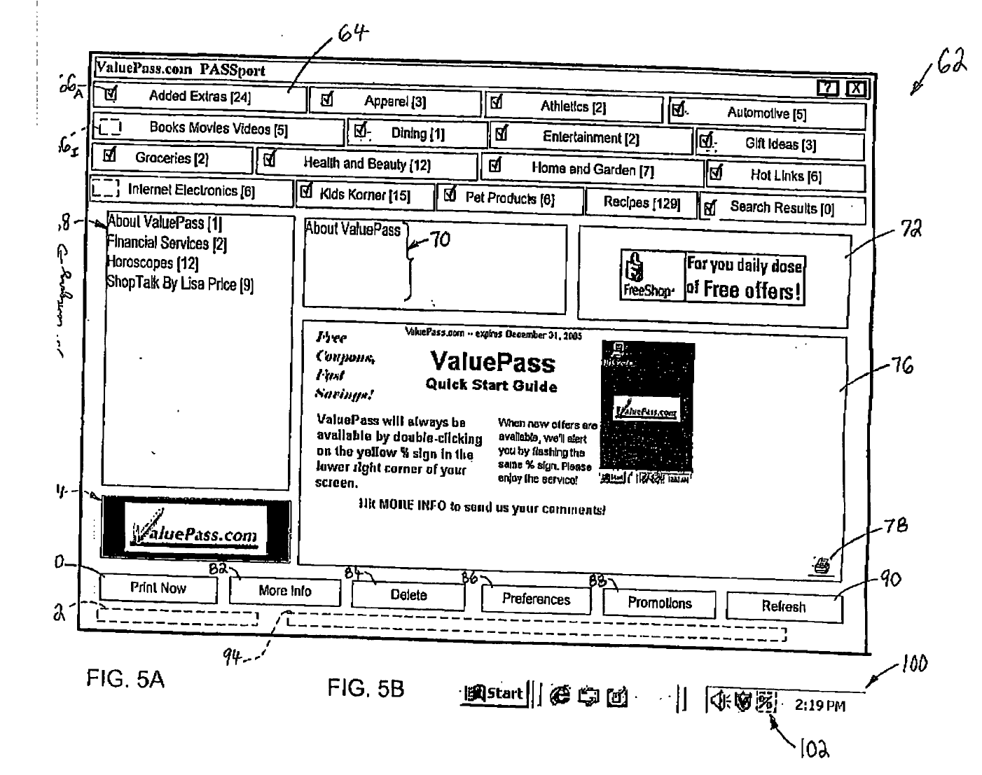

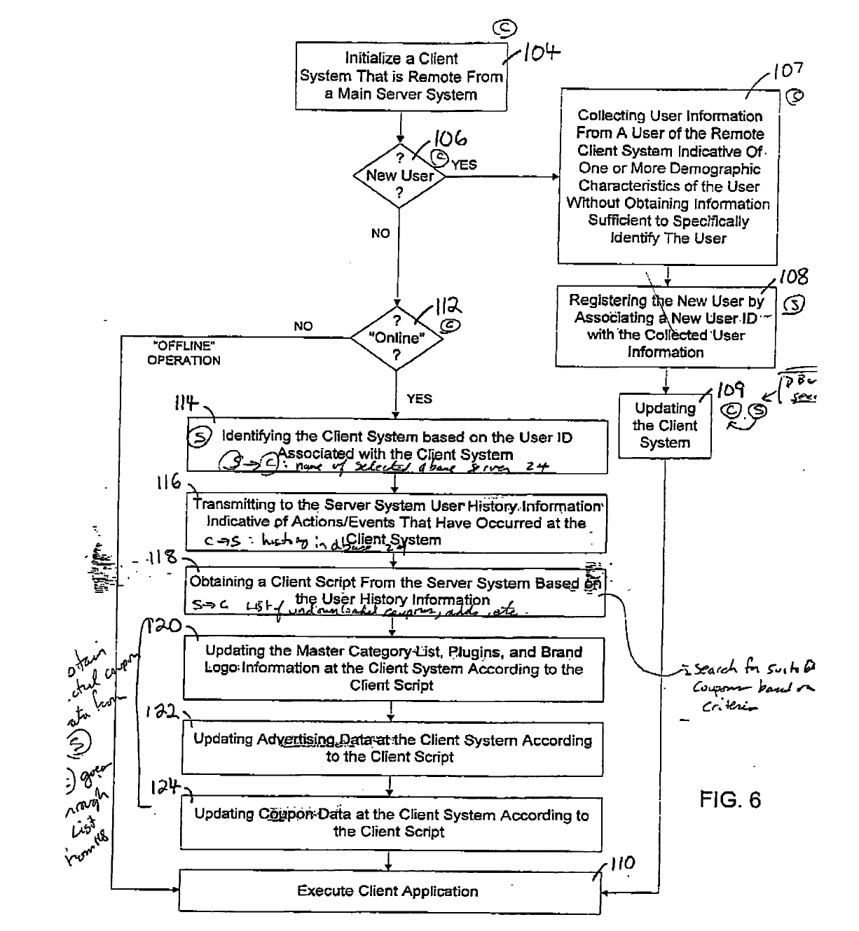

To provide communication between the main database system 12 and a user of the client database system 14, a user interface may be conveniently provided, as will be discussed in description of FIG. 5. The user interface can be installed on the client database system 14 at the time when a first communication is initiated with the main database system 12 or when a request to obtain a coupon is received by the main database system 12. The user interface can include any hardware, software or combination thereof that allows a user to interact with the main database system 12. The user interface can include one or more user interface objects, such as display regions, tabs, buttons and the like. The interaction with the user interface can be performed by an actual user, a third party or another program, such as a program created using macro programming language that simulates the action of a user with respect to the user interface.

### Coupon Database Server Architecture

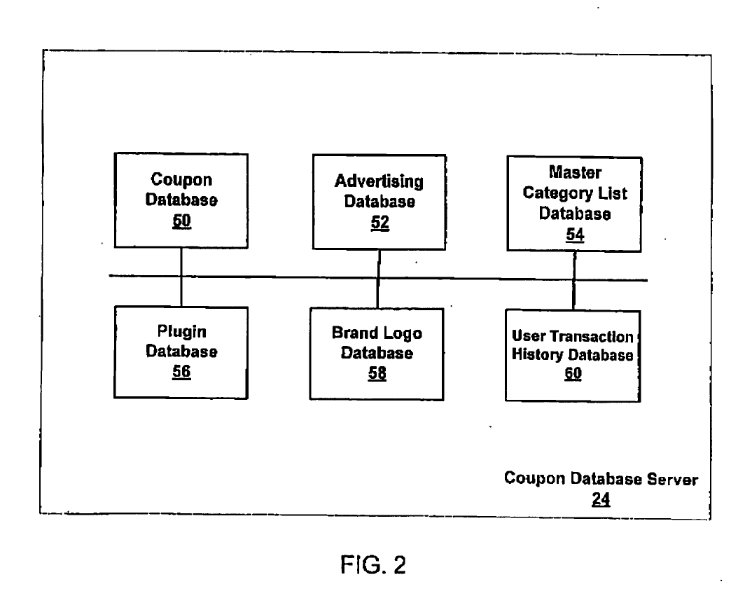

FIG. 2 illustrates exemplary components of a coupon database server 24. Referring to FIG. 2, the coupon database sever 24 generally includes a coupon database 50 for storing electronic coupons, an advertising database 52 for storing advertising information associated with one or more electronic coupons, a master category list database 54 for categorizing electronic coupons available on the main database system, a plug-in database 56, a brand logo database 58, and a user transaction history database 60.

Specifically, the coupon database 50 includes information corresponding to electronic coupons available. Such information can include, without limitations, sponsor name of an electronic coupon, product or service description of the electronic coupon, savings or discount amount associated with the electronic coupon, number of times the electronic coupon is available for printout, number of times a particular electronic coupon is printed out by a user, expiration date of the electronic coupon, optional text/image(s) on the electronic coupon and identification number of the electronic coupon.

In some implementations, the electronic coupons are categorized by the master category list database 54. The master category list database 54 can include coupon category names presently established with the main database system 12. Exemplary coupon category names include “Apparel”, “Athletics”, “Automotive”, and “Internet Electronics”. As will be discussed in FIG. 5, a user can select (or deselect) a category such that coupons pertaining to the selected category can be sent from the main database system 12 to the client database system 14.

In some implementations, each established category name can be displayed to the user (via an interface) using an unique display characteristic (e.g., color). In these implementations, information associated with the display characteristics can be stored in the master category list database 54.

In addition to storing electronic coupons, the main database system 12 also can be configured to store advertising impressions associated with advertisement of an electronic coupon. When a user prints the electronic coupon, one or more advertising impressions can be displayed on the printed electronic coupon. In some implementations, the advertising impressions are stored in the advertising database 52, and can contain text, images or combination thereof. The advertising database 52 can be in the nature of a master advertising database including all of the advertising impressions included in the main database system 12.

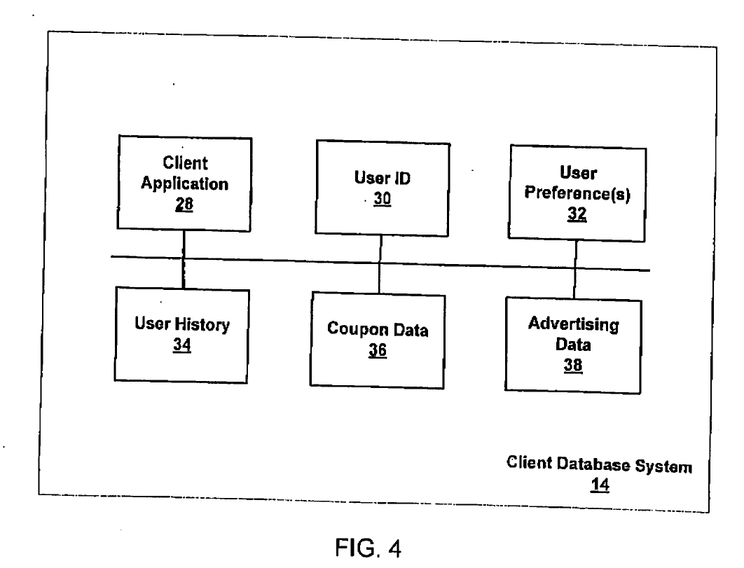

The plug-in database 56 includes one or more plug-ins or information associated with plug-ins available for use in connection with a client application (28) being executed on the client database system 14, as will be discussed in greater details with respect to FIG. 4. In some implementations, the particular plug-ins that are selected for use in connection with the client application depend on what functionality has previously been configured in the client database system 14. For example, plug-ins can be configured on the client database system 14 by the main database system 12 (e.g., via installation files) to provide Zodiac information, recipe information, and stock quote information to the user. Additionally, one or more plug-ins can be configured to provide a new coupon style for the user. As a result, the client database system 14 can be updated remotely with new functionality, giving the user of the client database system 14 the flexibility to view and access an electronic coupon according to a specific user preference.

The brand logo database 58 includes information associated with how the user interface (FIG. 5) interacting with the user and provided for communication between the main database system 12 and the client database system 14 is “branded”. In some implementations, the default “branding” of the user interface involves the display of a company logo. In these implementations, the company logo can be a company logo associated with an electronic coupon being obtained by the user, or a company logo previously configured by the main database system 12. Alternatively, the user interface can be branded with a company logo of a referring company that refers the user of the client database system 14 to the data distribution system 10. If desired, a corresponding internet uniform resource locator (URL) for “clickthrough” purposes can be established with the brand image.

The user transaction history database 60 includes information associated with user transaction history of the client database system 14. For example, the user transaction history database 60 can record communication information corresponding to actions or events taken by or involving the user of the client database system 14 (e.g., each time an electronic coupon is displayed or printed, the history database 60 can be updated to reflect this action taken by the user). The user transaction history database 60 also can contain a record of each downloaded/printed coupon or otherwise provided to the client database system 14.

### Main Database System Architecture

While only a coupon database server 24 has been demonstrated, the main database system 12 can include database servers, application servers and/or other software/hardware components. In some implementations, these database servers, application servers and/or software/hardware components of the main database system 12 can be configured to be connected to, or otherwise receive, coupon information from the issuer of such coupons (i.e., the coupon's sponsor). This function may be performed by a direct electronic connection with a sponsor system, or may involve loading data from a physically transportable data storage medium (e.g., diskette, tape, CD-ROM, etc.). The coupon sponsor can issue in connection with the coupon an associated set of instructions that define how the coupon is to be distributed. For example, such instructions can include restrictions as to a number of coupons that any one user may print out for redemption, a state and/or zip code associated with a user for such user to have access to the coupon, an expiration date, a sponsored item, a discount amount and the like.

Further, these database servers, application servers and/or software/hardware components of the main database system 12 can be configured to be connected to, or otherwise receive, advertising information from an advertising sponsor. Similar to receiving coupon information, this function can be performed by direct electronic connection with the advertising sponsor's system, or may involve loading data from a physically transportable data storage medium (i.e., diskette, tape, CD-ROM, etc.). The advertising impressions can be displayed to the user of the client database system 14, as described in greater detail later.

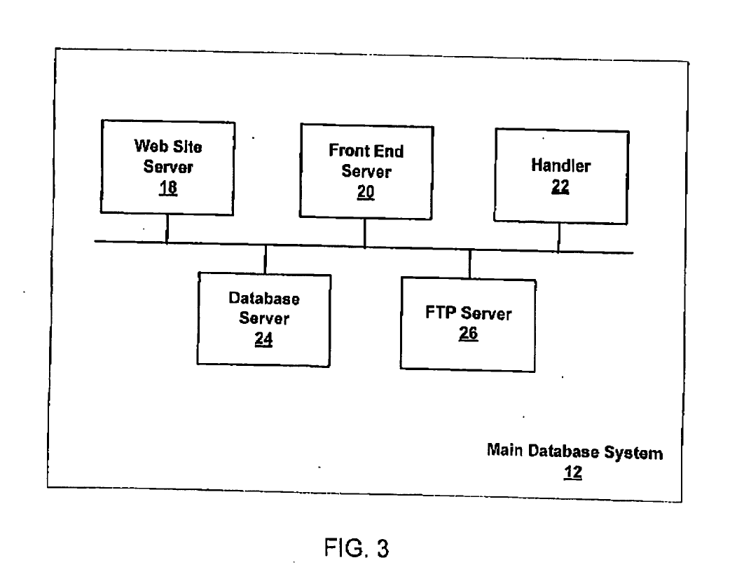

FIG. 3 illustrates exemplary components of a main database system. Referring to FIG. 3, the main database system 12 includes, in addition to the coupon database server 24 discussed with respect to FIG. 2, a website server 18 through which request for coupon distribution from the client database system 14 can be received, a front-end server 20 for providing one or more user interfaces to promote communication between the main database system 12 and the client database system 14, a handler 22 for handling coupon requests from the client database system 14 and an FTP server 26 for storing installation files associated with the setup of the client database system 14.

In some implementations, if the network 16 is in the form of an Internet, the website server 18 can be configured to provide “web pages” to consumers (including potential users of system 10) with access to the network 16. The Internet, more particularly, the World Wide Web portion thereof, “WWW”, is an interconnected computer network that is generally distributed throughout the world on discrete interconnected computer nodes having software interfaces generally referred to as “web pages”. Access to the Internet can be made by various methods. For example, a non-institutional user can obtain access from an internet service provider (ISP), which in turn obtain authorized access to the Internet. Navigation on the WWW portion of the Internet can involve knowledge of a directory structure of various nodes of the Internet (i.e., an “address” to each given resource on Internet). Such an address can be in the form of an URL, which typically starts with a protocol name followed by a domain name (e.g., http://www.valuepass.com).

The website server 18 also can be configured to provide an interface for effecting a download of client software that a consumer may perform and execute to establish the client database system 14 on a computer system so that the consumer can become an authorized user of the data distribution system 10. In particular, the website server 18 can refer an Internet consumer to the FTP server 26 for installation file(s) related to the client database system 14. Similarly, the FTP server 26 can be configured to operate in cooperation with the website server 18 to provide, for example, installation or setup programs. The installation program(s) can be downloaded to a general-purpose computer (e.g., PC or a MAC) for installation of the software associated with the client database system 14.

In some implementations, once the client database system 14 is installed and registered, the client database system 14 can initially request communication with the main database system 12 through the front-end server 20. Such request can be initiated at the start of each new session of the data distribution system 10 or when coupons on the main database system 12 (or the client database system 14) are updated. The front-end server 20 can provide multiple interface and allocation/direction features for the data distribution system 10.

In these implementations, after a new session is established by a user, all F subsequent requests sent by the client database system 14 can be directed to or “handled” by the handler 22. In response, the handler 22 interfaces with the coupon database server 24 by issuing a request or command to ensure that the request sent by the client database system 14 is fulfilled. Alternatively, the handler 22 can directly respond to the client database system 14 without such a request or command.

### Client Database System Architecture

FIG. 4 illustrates exemplary components of a client database system. The client database system 14 generally includes client application 28, user identification (ID) data 30, user preference data 32, user history data 34, coupon data 36, and advertising data 38. In some implementations, the client database system 14 also includes general purpose computing apparatus configured to operate in accordance with an operating system having a graphical user interface. The operating system can be, for example, MAC OS® by Apple Computer, Inc. of Cupertino, Calif., a Microsoft Windows® operating system, Linux, a mobile operating system, control software, and the like.

The client application 28 includes software compatible with and executing on the client database system 14 that can be configured to perform various functions including, but not limited to, collecting user information, including preferences, communicating with the main database system 12 through the network 16, and providing a user interface for a user to browse, select and print coupons. In some implementations, only authorized users can access the main database system 12 for obtaining electronic coupons. In these implementations, each authorized user can be assigned a user identification (ID) 30. The user identification (ID) 30 can include a multi-digit number or designated format that can be uniquely assigned by the coupon database server 24 or the main database system 12. For example, the user ID 30 can include a predetermined format, such as XXX/XXXXXXXX, where X is a digit between 0-9.

In some implementations, the user ID 30 can be stored on the client database system 14 as a part of an user information object, and be provided to the main database system 12 at the time when a request for new coupon data is transmitted. The main database system 12 can correlate the received user ID 30 with the user information previously registered and stored in its user profile database. The registered user information can then be used to identify coupons suitable for the user having the user ID 30.

In one aspect, the user ID 30 associates or represents a physical machine defining the client database system 14, and does not contain information associated with the user's personal identity. For example, the user information object includes general user information collected from the user of the client database system 14 indicative of one or more demographic characteristics of the user that can be updated after initial registration (e.g., a postal zip code associated with the user, or a state in which the user resides). As another example, the user information object can include the mode in which the Internet is accessed by the user, for example, through use of a modem (e.g., dial-up), a Local Area Network (LAN), or a proxy server. The user information object may further include the version number of the client application 28 installed on the client database system 14. Because the user information does not contain data personal to the user (e.g., band account, credit card, personal address or phone number), the privacy of the user of the data distribution system 10 can be maintained and potential theft of identity can be prevented.

Once a user ID 30 is established, a user can manually define a set of user preference data 32 unique to the established user ID. In some implementations, the user preference data 32 can be divided into two main groups. The first group of information includes data associated with a schedule on which the main database system 12 is checked for new coupons. Such data includes, without limitation, every one hour, every two hours, every four hours, once a day and twice a day. The first group of information also can include personal preferences indicating that certain types of coupons (of a particular category) be automatically printed (this may be selected or deselected by the user). The second main group of information contained in the user preference data 32 includes a comprehensive listing of categories manually selected by the user under which the coupons are to be received. If desired, the user can manually deselect a category, in which case coupons pertaining to that category are not sent from the main database system 12 to the client database system 14.

As discussed above, the user transaction history database 60 of the main database system 12 includes information associated with user history of the client database system 14. In some implementations, this information can be synchronized with the user history data 34 upon initiating a communication between the main database system 12 and the client database system 14. The user history data 34 includes, for example, data corresponding to events occurring at the client database system 14 and data pertaining to the operation of the client database system 14. These data can be stored in a user history file as part of the user history data 34. For example, when a user browses through the coupons available on the main database system 12, each coupon that is selected for viewing is noted in the user history file. Likewise, when a coupon is selected for printing, the printed coupon (and the date/time at which the coupon is printed) is also recorded in the user history file.

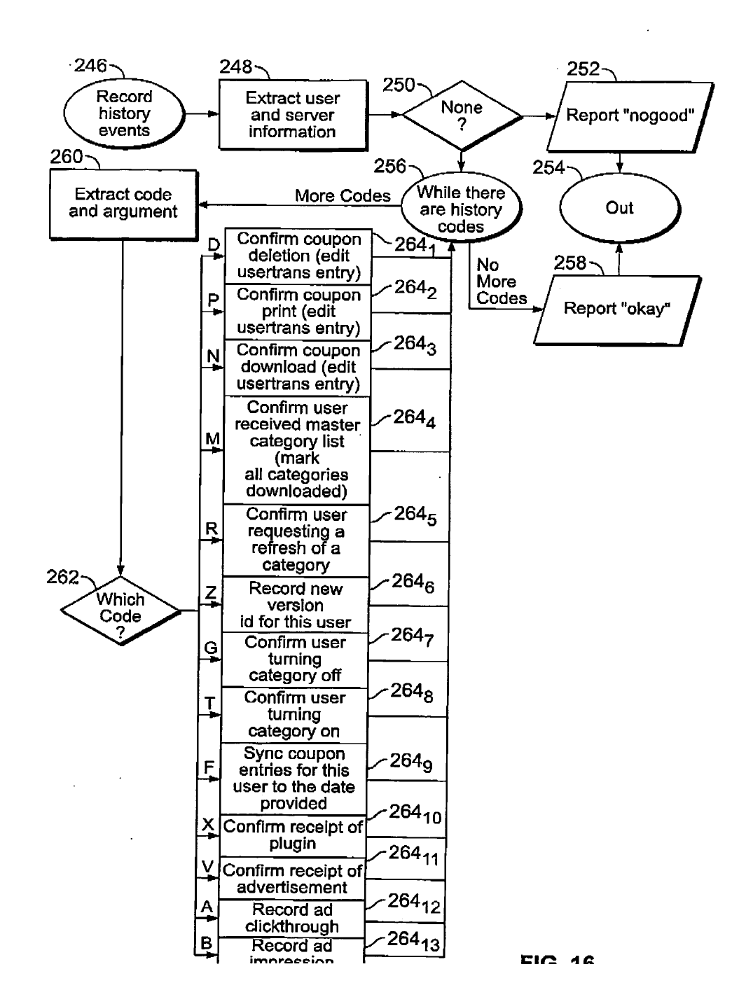

In some implementations, when a user selects (e.g., clicks) on an advertising impression provided by the advertising data 38, the advertising company or the product/services offered by the advertising company is noted in the user history data 34. The advertising data 38 can include one or more advertising impressions each having a predetermined text, image(s) or combinations thereof that can be displayed to the user as a function of (or otherwise independent from) a coupon category provided by the master category list database 54 and selected by the user. If desired, the advertising data 38 can be stored on the client database system 14 in an encrypted form. In this aspect, the information contained in the user history data 34 also can be encrypted by the client application 28 (e.g., in accordance with the encryption strategy defined by the client database system 14) to protect the integrity of the data. The contents of the user history data 34 will be described and illustrated in greater detail in connection with FIG. 16.

Coupon data 36 includes information corresponding to the electronic coupons available (e.g., for browsing) on the client database system 14. Similar to those stored in the coupon database 50 of the main database system 12, each electronic coupon can include, without limitations, sponsor name of an electronic coupon, product or service description of the electronic coupon, savings or discount amount associated with the electronic coupon, number of times the electronic coupon is available for printout, number of times a particular electronic coupon is printed out by a user, expiration date of the electronic coupon, optional text/image(s) on the electronic coupon and identification number of the electronic coupon.

In some implementations, when an electronic coupon is printed for redemption, additional information may be displayed on the “hard copy” of the electronic coupon. These additional information can include, for example, the user ID 30, demographic data such as the postal zip code, one or more items of the user information contained in the user preference data 32, date and time, and various Internet URLs. Accordingly, when a user redeems the electronic coupon, for example, at a retail store, information appearing on the coupon (which is eventually returned by the retailer to the coupon issuer or sponsor) can readily be made available to the coupon sponsor. This information can thereafter be used in analyzing and assessing the efficacy of various advertising/promotional strategies.

The coupon data 36 can be stored on a hard drive or the like associated with the client database system 14, and can be stored in an encrypted form. In some implementations, the coupon data 36 is first encrypted by the main database system 12 (e.g., based on an encryption strategy consistent with that defined in the main database system 12). The encrypted coupon data is then transmitted to the client database system 14. Upon receipt, the client database system 14 further encrypts the once-encrypted coupon data (in accordance with a client database system encryption scheme) to thereby generate a doubly encrypted coupon data. The doubly encrypted coupon data 36 can then be stored on the client database system 14. As a result of the foregoing encryption steps, the occurrence of fraud in the distribution of electronic coupons can be substantially minimized. A user, for example, can therefore not easily defeat the coupon counting scheme that limits the number of printouts by, for example, exploring the hard drive of the client database system 14, identifying coupon data, and thereafter producing duplicated copies of the coupons. In some implementations, the environment established by the client application 28 can be practically the only means for a user to obtain electronic coupons.

### Coupon Graphical User Interface

FIG. 5A shows an exemplary user interface for distributing coupons between a main database system and a client database system. Referring to FIG. 5A, a graphical user interface (GUI) 62 in connection with the execution of the client application 28 includes a plurality of main coupon category “buttons” 64 each having a respective status indicator 66 associated therewith. The GUI 62 also includes a coupon subcategory list 68, a coupon list 70, an advertising pane 72, a logo pane 74, a main coupon display area 76, an “Add-To-Print-Cart” button 78, a “Print Now” button 80, a “More Info” button 82, a “Delete” button 84, a “Preferences” button 86, a “Promotions” button 88, a “Refresh” button 90, a printout status display area 92, and a general message display area 94.

The main coupon category buttons 64 allow the user of the client database system 14 to select the general category of coupons that the user is interested in viewing. For example, the user who is interested in browsing through entertainment coupons would select the main category button 64 designated “Entertainment” using a pointing device such as a mouse (e.g., via “clicking” on the button). The status indicator 66 associated with each main coupon category button 64 indicates whether there are coupons under that main category that have not yet been displayed in the display area 76. As shown, when the status indicator 66 is “checked” (i.e., active), as indicated generally at 66_{A} for the main coupon category button labeled “Added Extras”, such indication informs the user that one or more coupons available under that main coupon category have not yet been displayed. Alternatively, when every coupon has been displayed under a main category, the “checked” status indicator 66 becomes inactive and is removed, as shown by a dashed line box designated 66₁ where a status indicator would otherwise be displayed had it been “active”.

When a main coupon category buttons 64 is selected, a corresponding subcategory list is displayed in the subcategory list 68. A user can browse through the subcategory names contained in the subcategory list 68 to make a selection. When a subcategory name is selected by the user (e.g., via “clicking”), the corresponding individual coupon(s) or informational message(s) is displayed in the coupon list 70. The user can select a coupon from the coupon list 70, which will then be displayed in the coupon display area 76.

Using the GUI 62, users of the data distribution system 10 can quickly and easily navigate from the main coupon categories to individual coupons for printout and later redemption. To print a particular electronic coupon, the user can select the print cart button 78 to add the selected coupon to a print cart or queue for subsequent printout using a connected (or network) printer. Alternatively, the user may print the selected coupon immediately by selecting the “Print Now” button 80. The “Print Now” button 80 can be configured under the client application 28 such that when selected, the coupon currently being viewed is automatically printed. If there are one or more coupons currently in a print queue, the “Print Now” button 80 can be configured to add each selected coupon to the print queue. Print status display area 92 also can be provided for displaying messages pertaining to the status of the print queue (e.g., “Items to Print: 2”). Alternatively, message display area 94 can be provided for displaying various messages associated with the electronic coupons to the user of the client database system 14.

As discussed previously in FIG. 4, the advertising data 38 includes one or more advertising impressions each having a predetermined text, image(s) or combinations thereof that can be displayed to the user as a function of a coupon category provided by the master category list database 54 and selected by the user. In these implementations, the advertising pane 72 can be configured to display such an advertising impression. For example, a vendor of electronic equipment may arrange to have an advertising impression for that vendor's company displayed in the advertising pane 72 when the “Internet Electronics” category button 64 and a corresponding coupon subcategory from the subcategory list 68 are selected by the user. An Internet URL (e.g., vendor's home page) also may be associated with the advertising impression displayed in the advertising pane 72.

In some implementations, the client application 28 can be configured such that when a user hovers and selects (e.g., “clicks”) the advertising pane 72, an internet browser program associated with the client database system 14 is launched and the user is directed to a web page specified by the advertising impression displayed in the advertising pane 72. This is a so-called “clickthrough” occurrence, which can be recorded in the user history file if desired.

The logo pane 74 provides a display area through which the GUI 62 can be “branded” using a brand logo or a company logo. In some implementations, the brand/company logo can be one selected by the brand logo database 58. Similar to the advertising pane 72, an Internet address may be established with the brand/company logo displayed in the logo pane 74 so that when the user clicks on the logo pane 74, an internet browser program associated with the client database system 14 is launched and the user is directed to a web page specified by the internet address.

Alternatively, the “More Info” button 82 can be configured to launch a default Internet browser program associated with the client database system 14 and to direct the browser program to the specified URL. In some implementations, coupons displayed in the coupon display area 76 can be redeemed by the user electronically (as opposed to printing and physically tendering the printed coupon to a retailer). In these implementations, a message can be displayed to instruct the user to click on the “More Info” button 82 to instantly redeem the coupon online. In response, the client application 28 can be configured to invoke a specified but completely hidden and inaccessible URL (including the appended promotional code) using the default internet browser program. The browser can take the user to a website (e.g., website associated with a coupon sponsor or an advertiser whose advertising impression is displayed in the advertising pane 72) corresponding the hidden and inaccessible URL, where the appended promotional code can be processed and redeemed by the user.

In implementations where the user readily have a promotional code provided by either the coupon sponsor or a third party, the “Promotions” button 88 can be selected which prompts the user to enter a promotion code to obtain a special promotional coupon that may not be available on the client database system 14.

Occasionally, the client database system 14 may communicate with the main database system 12 for new or updated coupons. If desired, the user can manually effectuate this update by selecting the “Refresh” button 90 to transmit an update request from the client database system 14 to the main database system 12. If desired, the update request can be configured to include the user history data 34 to be uploaded onto the main database system 12.

In some implementations, the refresh interval at which the client database system 14 is refreshed or synchronized with the main database system 12 can be automatically configured by the client database system 14 or manually established by the user using the “Preferences” button 86. In other implementations, the “Preferences” button 86 can be configured to allow the user to set and/or modify the information contained in the user preference data 32 (e.g., a listing of coupon categories under which coupons pertaining to the listed categories are to be received).

In some implementations, the client application 28 can disable access to the invoked URL or programming code associated therewith. As a result, hovering over the coupon displayed in the display area 76 does not cause the URL to be displayed or captured by “right-button clicking” mechanism. Unlike conventional web-based e-coupon distribution systems, the specified URL (and/or programming code) can be concealed from the user, and cannot be discovered by, for example, “right-clicking” on the coupon display 76. Accordingly, a secured electronic coupon distribution can be realized. To remove the currently displayed coupon, the user can simply click on the “Delete” button 84.

### Taskbar and Taskbar Icon

FIG. 5B shows an exemplary taskbar icon representative of a GUI executed by a client application. Referring to FIG. 5B, the graphical user interface associated with the operating system of the client database system 14 may include a taskbar 100. In some implementations, a taskbar icon 102 is provided. The client application 28 can be configured to display the taskbar icon 102 to the user in a first display state when no new coupons or messages are available to the user. The taskbar icon 102 in the first display state may assume a static display. In some implementations, the taskbar icon 102 includes a generally black-colored “%” symbol on a yellow-colored background, all enclosed by a dashed-line box. The client application 28 can be configured to display the taskbar icon 102 in a second display state different from the first display state when new coupons or messages are available for the user. In some implementations, the second display state associated with taskbar icon 102 includes a quasi-flashing display state where (i) the color of the “%” symbol is indexed or rotated through a plurality of different colors, and (ii) the dashed-line enclosure box is manipulated to give the sense of movement, particularly rotation, around the perimeter of the taskbar icon 102.

### Exemplary Processes and Flowcharts

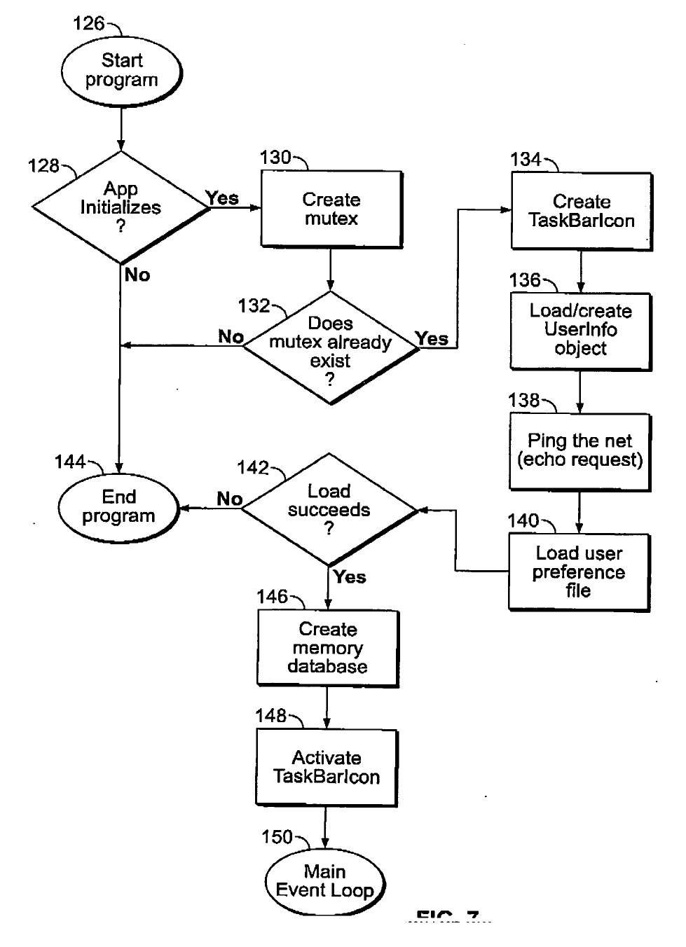

FIG. 6 is an exemplary flowchart diagram illustrating interactions between a client database system, and a main database system. In some implementations, each time a new session is commenced, one or more steps set forth in FIG. 6 will be performed.

Referring to FIG. 6, in step 104, the client database system 14, by way of execution of the client application 28, is initialized.

In step 106, the client application 28 determines whether there is an identified user for the client database system 14, or whether the present user is a “new” user. The client application 28 may make this determination based on the existence or absence of particular files on the client database system 14 (e.g., a file containing a user ID 30) indicative of whether or not this is a “new” user. If “NO”, then the process branches to step 112. Otherwise, if the answer to step 106 is “YES”, then the process branches to step 107.

In step 107, the client application 28 obtains user information from the user. In particular, the client application 28 can be configured to collect user information from a user of the client database system 14 indicative of one or more demographic characteristics of the user without obtaining information sufficient to specifically identify the user. In some implementations, the information obtained includes a postal zip code associated with the user, and a State where the user resides. Personal information such as the user's name, e-mail address, residence address, social security number, telephone number, and the like is not obtained in step 107. The foregoing step provides useful information to the main database system 12 in the selection of coupons appropriate for the user (e.g., geographic area). Coupons from merchants located geographically proximate to the user's residence may be conveniently redeemed by the user, thus increasing the efficacy of the coupon offer. Other information, such as the type of Internet connection (e.g., modem), may also be obtained from the user in step 107.

In step 108, the main database system 12 registers the “new” user. The main database system 12 determines whether the user of the client database system 14 is a “new” user based on the presence or absence of a user ID 30 in a message from the client database system 14 to the main database system 12. The “new” user is then registered on the main database system 12. The main database system 12 can be configured to register the new user by performing, among other things, the steps of allocating a new user ID, and associating the new user ID with the user information obtained in step 107. Accordingly, the client database system 14 can always be identified by its user ID.

In step 109, the client database system 14 and the main database system 12 communicate with each other so as to update the master category list, plug-ins, brand logo information, advertising data and coupon data at the client database system 14. This is done, for the first time the client application 28 is executed, by searching the main database system 12 for new information that has come into being between the time the installation or setup program that the user used to install the client database system 14 was populated with such data (the “sync” date), and the present time (the server date). The identified information is downloaded to thereby update the client database system 14. This step ensures that the user of the client database system 14 has the most up-to-date information in these categories. The process then proceeds to step 110 in which the client application 28 is executed.

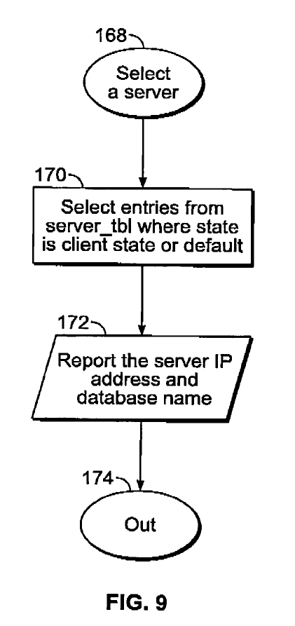

When the answer to step 106 is “NO”, then the process branches to step 112. In step 112, the client application determines whether the client database system 14 is “online”. The client database system 14 is “online” when the user is connected to the Internet such that the client database system 14 can communicate with main database system 12. While this basic step will be described in greater detail in FIG. 8, in some implementations, the client database system 14 will not force a connection to the network 16. Rather, if there is no “online” connection, the user of the client database system 14 will have access to coupons in an “offline” mode. Thus, if the answer to step 112 is “NO”, then the process branches to step 110. Otherwise, when the answer step 112 is “YES”, then the process branches to step 114.

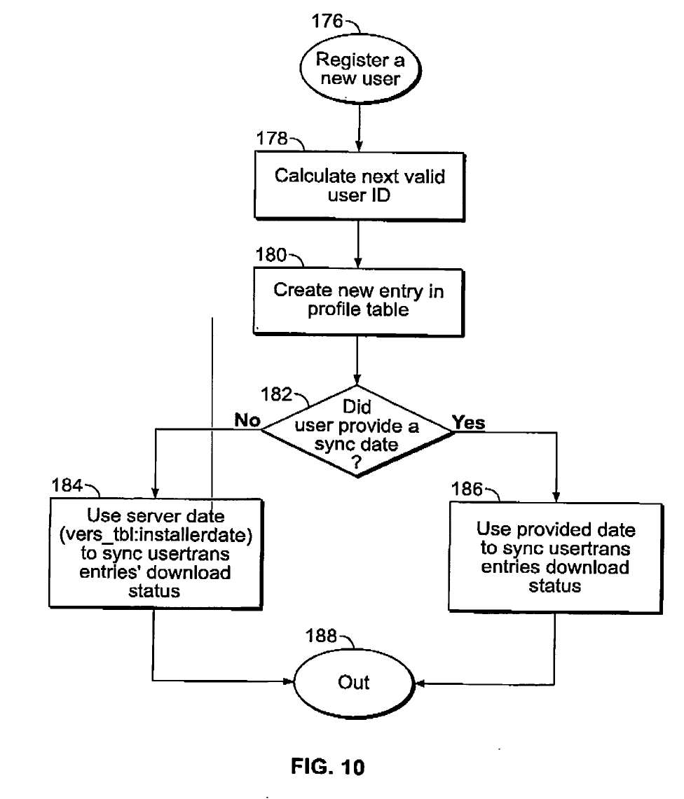

In step 114, the main database system 12 identifies the client database system 14 based on a user ID 30 provided by the client database system 14. Thus, the main database system 12 can utilize the information “on file”, such as state and zip code, for a variety of purposes. In some implementations, the state and zip code data are included in a request by the front-end server 20 to the coupon database server 24 to select a server that will service this user for this session (described in detail in connection with FIG. 9). The response to the request is a virtual IP address to a particular handler 22, and a selected database “name” of a selected coupon database server 24.

In step 116, the main database system 12, particularly the assigned handler 22 and database server 24, is updated with any information contained in the user history file 34 that has not yet been uploaded and processed. The user history file contains information indicative of actions taken by, or, events occurring in response to actions taken by, the user of the client database system 14. As described above, the user history file 34 contains information such as the identity of coupons selected, coupons printed, advertising impressions displayed in the advertising pane 72, etc. The assigned handler 22 in conjunction with the database server 24 uses the user history file in at least two ways: (i) to produce data from which a user script can be built by the client database system 14 and, (ii) to update the user transaction database 60, which may then be queried to prepare reports that will be provided as feedback to the various advertising sponsors, coupon issuers, and coupon referral agents.

Step 118 involves obtaining a client script for execution by the client database system 14. Step 118 includes the substep of identifying coupons at the main database system 12 suitable for the user. What is suitable for any particular user may be based on the user ID, the user information associated with the user ID, the main coupon categories selected by the user, the OS platform (e.g., MAC OS® by Apple Computer, Inc. of Cupertino, Calif. or Microsoft Windows® operating system), the version of the client application 28, the cobrand ID, and the promotional code, if any. Use of these criteria can be either inclusive or exclusive. The client database system 14 may be sent lists of undownloaded coupons, undownloaded advertisement, etc. The lists may only identify, for example, the coupons to be downloaded (not the coupon itself). Steps 120, 122, and 124 involve obtaining the actual coupon data, advertisement data, as will be described below.

In step 120, the master category list, plug-ins, and brand logo information are updated, based on execution of the client script by the client database system 14. Particularly, the client database system 14 works through the list of the needed items.

In step 122, advertising data including advertising impressions from the advertising database 52 are updated at the client database system 14. This step ensures that the user has the most up-to-date advertising available. Again, the client database system 14 works through a list of needed ads, sequentially making requests from the coupon database server 24.

In step 124, coupon data from the coupon database 50 is updated at the client database system 14. Updating the coupon data includes retrieving coupon data corresponding to the identified electronic coupons (i.e., the list provided as part of the client script).

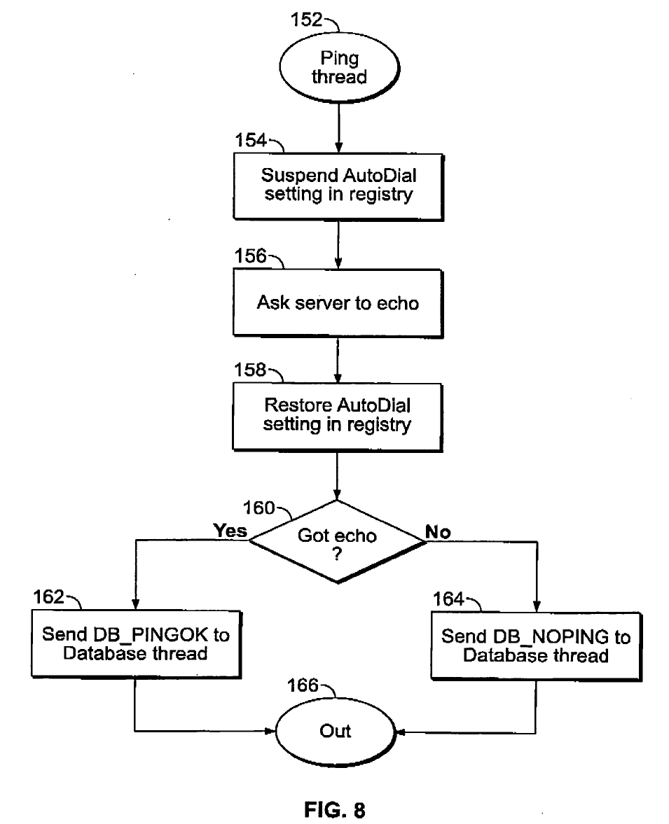

FIG. 7 is an exemplary flowchart diagram showing, in greater detail, an initial steps as discussed with respect to FIG. 6 for system initialization.

Referring to FIG. 7, the process begins in step 126 with an initiation of the client application 28. In step 128, if the client application 28 properly initializes, then the process branches to step 130. Otherwise, the process branches to step 144 where execution of the client application 28 ends.

In step 130, a “mutex” is created by the client application 28. “Mutex” stands for “mutually exclusive.” Programs or code segments that establish a mutex prevent other programs or code segments from running if they try to establish a mutex with the same ID. The client application 28 employs mutex functionality in the Microsoft Operating system to ensure that only one instance of the client application 28 is running on any given client database system 14. A second instance would be denied use of the mutex, and that instance would then exit.

In step 132, a test is performed to determine whether the mutex already exists. If the answer is “NO”, the process branches to step 144 where the client application 28 ends. However, if the response to the inquiry in step 132 is “YES”, then the process branches to step 134.

In step 134, taskbar icon 102 is created by the client application 28. The taskbar icon 102 is graphically illustrated in FIG. 5B. As described above, a quasi-flashing taskbar icon 102, in some implementations, is a visual alert to the user of the client database system 14 that new coupons or offers are available for browsing. The process then proceeds to step 136.

In step 136, a user information object is loaded (if it already exists) or created (if it does not already exist). If this is the first time the client application 28 has been executed, the user information object is created. As described above, the user information object includes user ID 30, demographic data, proxy server information, if any and software version number. This information may be stored, for example, on a hard drive portion of the client database system 14. The process then proceeds to step 138.

In step 138, the client database system 14 transmits an echo request to the main database system 12, which is received by the front-end server 20. Inasmuch as the client database system 14 may be connected to the Internet in a variety of logically and physically different configurations (e.g., dial-up connection, proxy server, hidden proxy server such as in the case of AOL, etc.), step 138 is provided to ensure a virtual channel for messaging between the client database system 14 and the main database system 12. The process then proceeds to step 140.

In step 140, a user preference file containing user preference data 32 is loaded into the memory of the client database system 14 for use by the client application 28. Initially, a default set of information is used, in which all coupon categories are selected and the refresh interval is set to 4 hours. The process then proceeds to step 142.

In step 142, a test is made by the client application 28 to determine whether the user preference file has loaded successfully. If the answer to this inquiry is “NO”, then the process branches to step 144 (“end program”). This may occur when the user preference file has been deleted, for example. On the other hand, if the answer to step 142 is “YES”, then the process branches to step 146.

In step 146, a memory database is created for maintaining user history events. This database can be configured to contain the user actions taken by the user, advertising impression displayed, etc., and to store the same for later transmittal to the main database system 12 as a user history file 34.

In step 148, the taskbar icon 102 (FIG. 5B) is activated. This provides a visual cue to the user that the client application 28 is available, and that coupon lists may be browsed, coupons can be selected and printed, or any other function available on the client application 28. In some implementations, the taskbar icon 102 alerts the user to new coupons or offers.

In step 150, the client application 28 begins a main event loop processing. In the main event loop processing, certain action, such as, for example, selecting a main coupon category, selecting a coupon subcategory, selecting a particular coupon, displaying a coupon, printing a coupon, refreshing the local coupon database, may be initiated by the user and detected and executed by the client application 28. While the main event loop processing may be invoked manually by the user of the client database system 14, operating systems can allow the user to specify whether the execution of the client application 28 should occur during startup of the computer on which the client database system 14 resides. Accordingly, without any further intervention by the user, the client application 28 will initialize upon each startup of the client database system 14.

FIG. 8 is an exemplary flowchart diagram showing, in greater detail, an echo request step (e.g., the “echo request” or “ping the net” step) as discussed with respect to FIG. 7.

Referring to FIG. 8, the process begins in step 152 where the “ping thread” portion of the client application 28 commences execution.

If the client database system 14 is not “online”, the client application 28 will not force an Internet connection. Thus, in step 154, the client application 28 suspends the “AutoDial” setting in the Windows registry. This ensures that the echo request to the front-end server 20 does not automatically cause a dialog window to be presented to the user asking for ISP Identification and Password information.

In step 156, the client database system 14 through execution of the client application 28, transmits a request to front-end server 20 to echo. The nature of the requested “echo” may simply be a return transmittal of an acknowledgement from the front-end server 20.

In step 158, the “AutoDial” setting is restored in the Windows registry.

In step 160, the ping thread performs a test to determine whether the requested “echo” was received by way of a return transmission from the front-end server 20. If the answer to this inquiry is “YES”, then the process branches to step 162, wherein a positive indication that an echo response to the echo request was returned to the client database system (“DB_PINGOK”) is generated. The positive indication is provided to the client application 28 (particularly, a database thread portion thereof).

Otherwise, if no echo was received from the front-end server 20, then a negative indication (“DB_NOPING”) is sent to the database thread in step 164. In either case, control from steps 162 and 164 both proceed to step 166, which is an exit step from the ping thread portion of the client application 28.

FIG. 9 is an exemplary flowchart diagram showing a server selection routine performed by a main database system.

Referring to FIG. 9, in some implementations, this “server select” operation occurs immediately after a successful “echo request” operation (FIG. 8). One or more coupon database servers 24 are preferably deployed, the particular number of which is selected to match the quantity of incoming requests (“load”) from the multiplicity of the client database systems 14 installed remotely. Step 168 marks the beginning of the process. At this point, the main database system 12 has in its possession at least the demographic information previously collected (e.g., state and zip code) even if it's a “new user” with no assigned user ID yet. The coupon database server receives the request. The process then proceeds to step 170.

In step 170, a coupon database server 24 routine selects entries from a server table where the state in the table matches the state of residence provided by the client database system 14. The table entry information defines the logical entities that will service this client database system 14.

In step 172, an Internet Protocol (IP) address and a database name are reported over the network 16 to the client database system 14. Subsequent requests during this session from the client database system 14 regarding requests for updated data and the like will be sent in a message addressed to the selected server IP address (which points to a handler 22), and will include in that message the selected database name, which logically maps to entries selected in step 170 (e.g., these may be various advertising databases 52, coupon databases 50, etc.). The selected IP address, in-effect, is a virtual IP address since there are a plurality of coupon database servers 24, perhaps arranged in a cluster, that are physically provided in order to provide the desired load carrying capacity. The routing function is performed on the main database system 12 by the handler 22. Such routing software and/or hardware may include conventional apparatus known to those of ordinary skill in the art. The process ends in step 174.

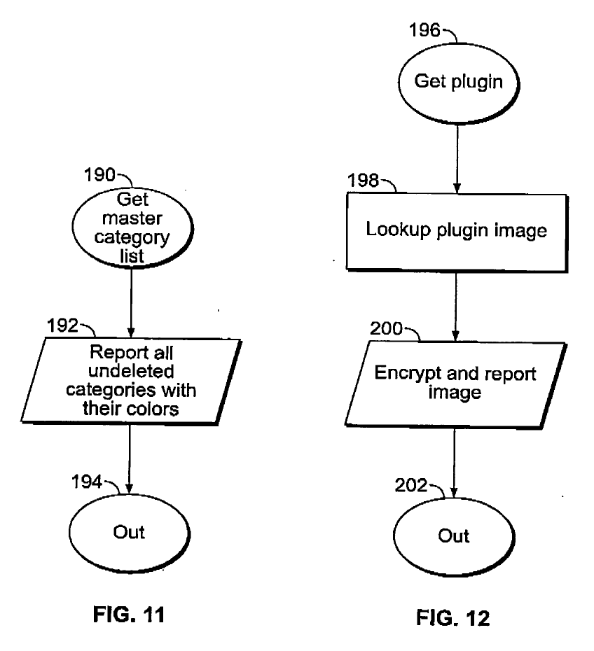

FIG. 10 is an exemplary flowchart diagram showing a process for registration of a new user by a main database system.

Referring to FIG. 10, the process begins in step 176 with commencement of the registration routine. In step 178, a new user ID is calculated by the coupon database server 24.

In step 180, a new entry or record is created in a user profile table. The profile entry will associate the user ID with the user information collected from the user. The process then proceeds to step 182.

In step 182, the coupon database server 24 determines whether a “sync date” was provided from the client database system 14. This is a date that describes how “up-to-date” the client database system 14 is, particularly the coupon and advertising information portions thereof. The use of the sync date has been described above in connection with FIG. 6. This “sync date” is automatically provided from the client database system 14 to the coupon database server 24 via the assigned handler 22. If a “sync date” was not provided by the client database system 14, then the process branches to step 184 where a nominal sync date based on the version of the software installed on the client database system is used for downloading and updating purposes. Alternatively, if the answer to step 182 is “YES”, then the process branches to step 186.

In step 186, the date provided by the client database system 14 is used as the “sync date” to synchronize the data on the client database system 14 relative to the master data on the main database system 12. In some implementations, the “sync date” is not a date that the client application 28 solicits from the user, but rather, is simply a date available within the client application 28 relating to how “current” the data is (i.e., coupon/advertising data, etc.). In either case, the process proceeds to and ends at step 188.

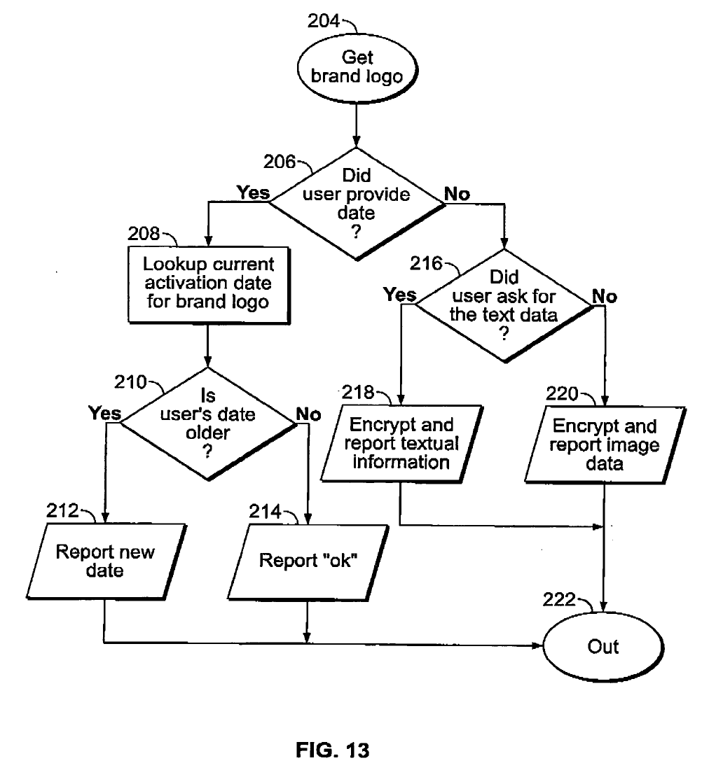

FIGS. 11-13 are exemplary flowchart diagrams showing, in greater detail, a process of updating a master category list, plug-ins, and brand logo information, respectively, as discussed with respect to FIG. 6.

Referring to FIG. 11, step 190 represents a request to obtain a master category list (i.e., the up-to-date list). This request is made from the client database system 14 to the selected coupon database server 24 via handler 22. Such a request is directed to the selected “virtual” IP address as described above. The master coupon category list (e.g., “Athletics”, “Automotive”, “Internet Electronics”, etc.) may be updated on the main database system 12, particularly the coupon database server 24. That is, categories may be added, and/or categories may be deleted. In either case, such a change will be reflected in the GUI 62 of the respective client database system 14 when the next session is invoked by a user.

In step 192, all undeleted master coupon categories, along with their display color (as displayed on display 40 of the client database system 14) are reported to the client database system 14 for use by the client application 28. Step 194 ends the master coupon category list updating process.

Referring to FIG. 12, step 196 represents a request from the client database system 14 to the coupon database server 24 via the handler 22 to obtain a new or an up-to-date plug-in(s). In some implementations, for an existing user, the client database system 14 may be executing a client script that includes a list containing needed plugins. The process outlined in FIG. 12 would be executed for each plug-in on the list.

In step 198, the coupon database server 24 performs a look-up of the needed plugin to locate the corresponding plug-in file (or image).

In step 200, an “image” or copy of the file of the sought-after plugin is encrypted in accordance with a main database system encryption strategy, and is reported or transmitted via the network 16 to the client database system 14. In step 202, the plugin update process is completed.

Referring to FIG. 13, steps 204-222 illustrate the steps involved in determining whether to maintain a default brand logo in logo pane 74 (FIG. 5A), or, in the alternative, whether to download a different brand logo. While a default brand or company logo is associated with the client database system 14 initially, the default may be changed. For example, a user of the network 16 may be informed of the existence of the data distribution system 10 by a third-party vendor who also maintains a website, and refers that Internet user to the website server 18 of the main database system 12. The referral mechanism, a hyperlink or the like to the website server 18, appends the identification of the referring vendor to the HTTP reference (the ID herein referred to as the “cobrand ID”). The website server 18 can be configured to recognize and respond to such appended data (the cobrand ID) by putting a “cookie” (i.e., a file used by Internet browser programs) on such Internet user's computer system that contains the cobrand ID. Then, if such potential user of the data distribution system 10 decides to download and install the client software, the client installation software will search for the “cookie”. If it finds the “cookie” and certain other qualifying criteria are satisfied, then the cobrand ID will be passed to the main database system 12 upon installation with a request to download the text or image data of the other (non-default) brand logo.

In some implementations, a client database systems can be deployed with both a default brand logo, and an alternate brand logo (including text/images). The following steps apply when the client application 28 determines that it should display an alternate brand logo.

In step 204, the client database system 14 requests a brand logo (non-default). The process proceeds to step 206.

In step 206, the coupon database server 24 determines whether the client database system 14 has provided a date along with the request for the alternate brand logo. If the data has been provided, then the client database system 14 already has the text/images corresponding to the brand logo, and only needs to determine whether to turn the requested brand logo “on” at the client database system 14.

Thus, if the answer to step 206 is “YES”, then the process branches to step 208. In step 208, the coupon database server 24 conducts a look-up to determine an activation date for the subject brand logo. The process then proceeds to step 210.

In step 210, the coupon database server 24 determines whether the client-provided date is “older” than the current activation date. If “YES”, then the process branches to step 212, where the new activation date is reported out to the client database system 14. The client database system 14 will therefore defer activation of the alternate, non-default brand logo until such new date. Otherwise, the process branches to step 214, where the coupon database server 214 reports an “ok” to the client database system 14. The client database system 14 will then implement (i.e., display) the brand logo corresponding to the cobrand ID.

When the process branches to step 216, (a “NO” to step 206), the coupon database server 24 performs another test to determine whether the client database system 14 asked for text corresponding to the cobrand ID. If “YES”, then the process branches to step 218, where the textual information is encrypted according to a main database system encryption strategy, and reported out to the client database system 14. Otherwise, step 220 is performed, where image data corresponding to the cobrand ID is encrypted (according to a main database system encryption strategy), and reported to the client database system 14. The process ends in step 222.

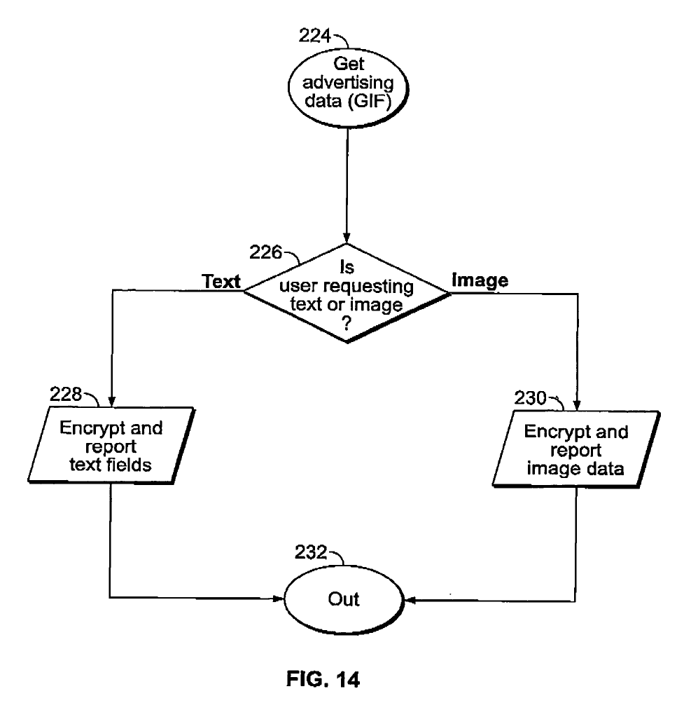

FIG. 14 is an exemplary flowchart diagram showing, in greater detail, a step of updating advertising data (e.g., “updating advertising data” of step 122) as discussed with respect to FIG. 6.

Referring to FIG. 14, in steps 224-232, advertising text, and images are encrypted to thereby provide secure transmission to the client database system 14. In some implementations, for an existing user, the client database system 14 may be executing a client script that includes a list containing needed advertising impressions. The process outlined in FIG. 14 would be executed for each advertising impression on the list.

As shown, step 224 marks the beginning of the advertising update process.

In step 226, the main database system 12 determines whether the user, more particularly the client database system 14, is requesting “text” or “image” advertising data. If the answer is “text”, then the process proceeds to step 228.

In step 228, the main database system 12, particularly the coupon database server 24, encrypts the text of the advertising data, and reports out the resulting encrypted advertising data. In some implementations, this encryption occurs in accordance with a main database system encryption strategy.

Otherwise, the process proceeds to step 230 when the advertising data requested is “image” data. In step 230, the advertising data (“image” data) is encrypted by the main database system 12 according to a main database system encryption strategy, resulting in encrypted advertising image data. The encrypted ad image data is then reported out to the client database system 14.

Step 232 defines the end of the advertising update process.

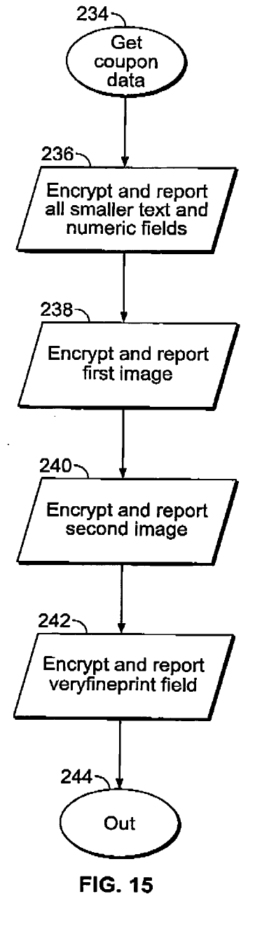

FIG. 15 is an exemplary flowchart diagram showing, in greater detail, a step of updating coupon data (e.g., “updating coupon data” of step 124) as discussed with respect to FIG. 6.

In some implementations, for an existing user, the client database system 14 may be executing a client script that includes a list containing needed coupon data. The process outlined in FIG. 15 can be executed for each electronic coupon on the list.

As shown, steps 234-244 illustrate that the coupon text and image data are encrypted in accordance with a main database system encryption strategy prior to transmission to the client database system 14, resulting in an encrypted coupon data. In some implementations, steps 234-244 in FIG. 15 occur at the main database system 12. Since the coupon data is encrypted, even if intercepted, the actual coupons cannot be easily recovered and reprinted. This reduces the occurrence of fraud.

Referring to FIG. 15, in step 234, the client database system 14 issues a request to get a particular electronic coupon. In step 236, the coupon database server 24 encrypts and reports (to the client database system 14) all smaller text and numeric fields. In steps 238 and 240, the coupon database server 24 encrypts and reports, respectively, first and second images associated with the requested electronic coupon. In step 242, the very fine print portions of the requested e-coupon in encrypted and reported out to the client database system 14. Step 244 is an exit step.

FIG. 16 is an exemplary flowchart diagram showing, in greater detail, a step of updating a main database system with a user history file (e.g., “transmitting to the main database system user history information” of step 116) as discussed with respect to FIG. 6.

Referring to FIG. 16, steps 246-264 occur principally on the main database system 12, more particularly, between the handler server 22 and the coupon database server(s) 24. Prior to step 246, the client database system 14 sends a message to the coupon database server 24 containing the user history file 34. Step 246 marks the beginning of the process used by the main database system 12 in recording the events contained in the user history file 34.

In step 248, the user and server information are extracted from the user history file 34. This information is used in updating the user transaction records associated with the identified user of data distribution system 10. The information developed in this process is also used to generate a client script that will be described in further detail.

In step 250, a test is made to determine whether there is any user and server information in the user history file. If the answer to this inquiry is “NONE”, then the process proceeds to step 252 where an indictor “NO GOOD” is reported out. The process then continues to step 254 where the process exits.

On the other hand, if the user and server information is successfully extracted from the user history file, the process continues at step 256. In step 256, a “WHILE DO” process structure is established. Process steps 256, 260, 262, and 264 are continuously repeated while there are new history codes remaining to be read-out and extracted from the user history file 34.

In step 260, the next history code is extracted along with any arguments pertaining thereto. The process then proceeds to step 262, and 264 where the extracted user history codes are decoded. For example, a user history code designated “F” indicates that coupon entries should be synchronized, for this user to the date so provided as the argument (i.e., to the so-called “sync date”). This is shown in block 264₉. As another example, a user history code “B” specifies that an advertising impression described in the argument should be recorded in a user transaction record. This is shown in block 264₁₃. The advertising impression, when recorded, may be used thereafter to prepare reports for the sponsor of the advertising impression. Other user history codes involve modification of a user transaction entry. For example, the code “N” indicates a positive confirmation by the client database system 14 that certain coupons were downloaded successfully. Accordingly, the user transaction entry should be edited to so indicate. As a result, positive feedback can be provided as to what coupons have been safely received at the client database system 14. FIG. 16 identifies thirteen codes, and corresponding responses, respectively designated 264₁-264₁₃.

When the last remaining history code has been extracted and decoded, the “WHILE DO” loop at step 256 fails, and the process proceeds to step 258. In step 258, the coupon database server 24 reports an “Okay” message to the handler 22. The process then proceeds to an exit step, designated step 254.

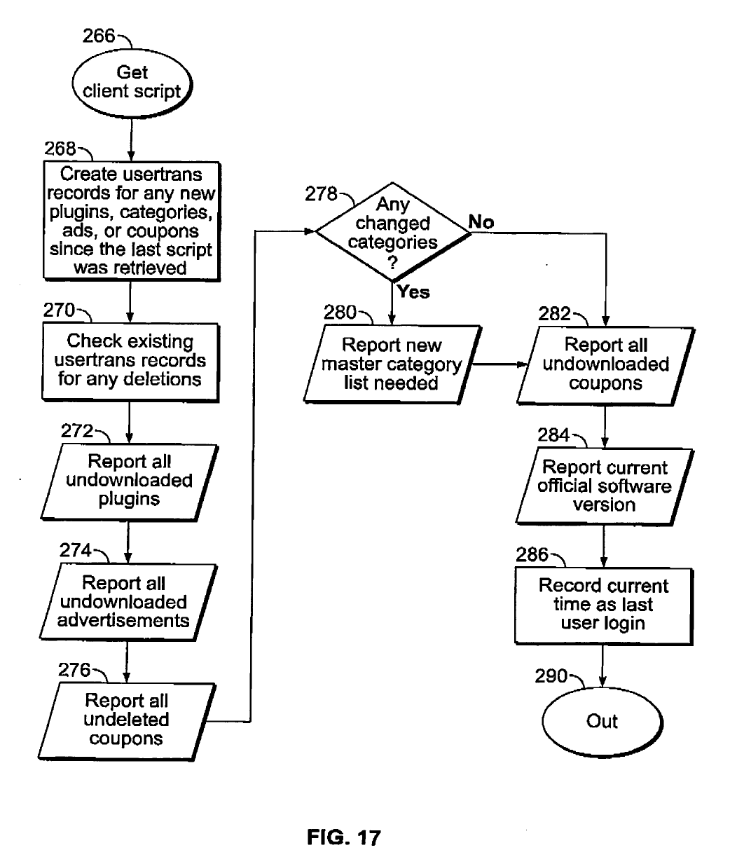

FIG. 17 is an exemplary flowchart diagram showing a process involved in obtaining a client script.

Referring to FIG. 17, after the user history codes from the user history file 34 have been extracted and decoded, a “client script” is built by the client database system 14 based on information (e.g., lists) received from the handler 22 in cooperation with the coupon database server 24. The client script provides instructions for the client database system 14 to execute.

In step 266, the client database system 14 issues a request to the handler 22 to obtain the “user” or “client” script. The client script is then returned to the client database system 14. Step 268 shows the execution of the client script by the client database system 14, which issues the command shown in the steps 268-290.

In step 268, the client database system 14 issues a command via the handler 22 to the coupon database server 24 to create user transaction records for any new plug-ins, main coupon categories, advertising data, or coupon data received by the client database system 14 since the last client script was retrieved.

In step 270, the client database system 14 issues a command via the handler 22 to the coupon database server 24 to check existing user transaction records for any deletions. Any deletions are processed whereby the affected user transaction record will be modified to indicate that the client coupon has been deleted.

In step 272, the client database system 14, in execution of the client script, issues a command via the handler 22 to the coupon database server 24 to report all undownloaded plug-ins. The coupon database server 24, through the handler 22, returns a message containing a listing of all undownloaded plug-ins. This list will be processed by the client database system after the client script has been completed.

In step 274, the client database system 14, in execution of the client script, issues a command via the handler 22 to the coupon database server 24 to report all undownloaded advertising impressions. The coupon database server 24 returns a list of all undownloaded advertising impressions.

In step 276, the client database system 14, in execution of the client script, issues a command via the handler 22 to the coupon database server 24 to report all undeleted coupons.

In step 278, the client database system 14, in execution of the client script, issues a command via the handler 22 to the coupon database server 24 to determine whether any of the main coupon categories have been changed. If the answer to this inquiry is “YES”, then the process continues at step 280, wherein the coupon database server 24 reports to the client database system 14 that a new master category list is needed. The process then proceeds to step 282.

If the answer to the inquiry in step 278 is “NO”, then the process proceeds to step 282. In step 282, the client database system 14, in execution of the client script, issues a command via the handler 22 to the coupon database server 24 to report all undownloaded electronic coupons. The coupon database server 24 returns a listing of all undownloaded coupons.

In step 284, the client database system 14, in execution of the client script, issues a command via the handler 22 to the coupon database server 24 to report the current official software version. The coupon database server 24 returns the latest version number.

In step 286, the coupon database server 24 is requested to record the current time as the last user login. The process then continues to step 290, which marks the end of the client script execution.

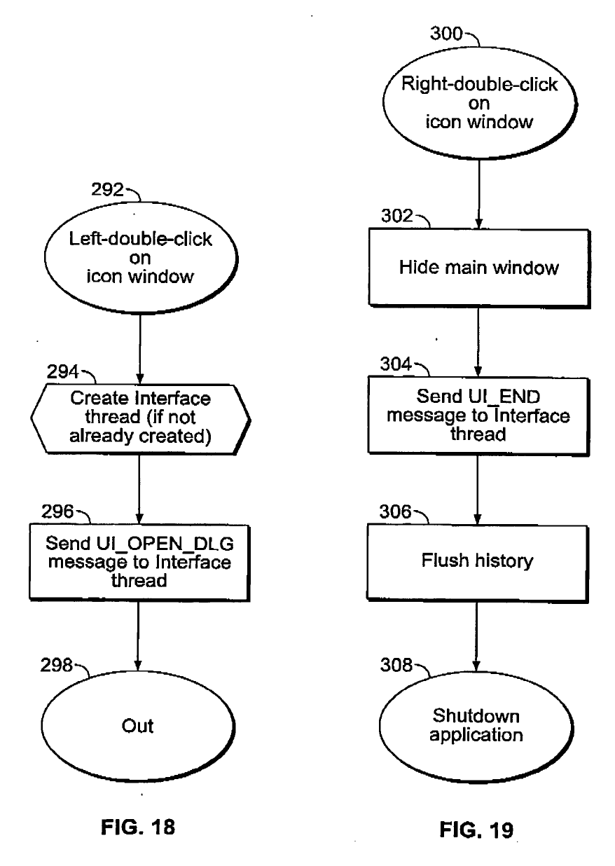

FIGS. 18-19 are simplified flowchart diagrams showing alternate responses taken by a client database system in response to double-clicking a taskbar icon.

Referring to FIGS. 18 and 19, upon initial execution of the client application 28, a taskbar icon 102 is created, as illustrated in FIG. 5B. As shown in FIG. 18, steps 292-298 illustrate the steps that the client application 28 performs when the taskbar icon 102 is left double clicked. Step 292 marks the beginning of the process that initiates the display of the GUI 62. Step 292 is performed when it is detected that the user has left-double-clicked on the taskbar icon 102.

In step 294, the client application 28 creates an interface thread, unless the GUI 62 has already been created by a preexisting interface thread.

In step 296, a user interface open dialog message is sent to the interface thread by the client application 28. The result of the execution of steps 294 and 296 generates a display similar to that shown in FIG. 5A.

In step 298, the process that creates the GUI 62 via an interface thread exits.

Referring to FIG. 19, in step 300, the client application 28 determines (via the operating system, for example) when the taskbar icon 102 has been right double clicked, and enters the process of steps 300-308.

In step 302, the “window” in which the GUI 62 would generally be displayed is hidden from the user (i.e., disappears from the display as viewed on a monitor of the client database system 14).

In step 304, the client application 28 sends a user interface-end message to the interface thread portion of the client application 28.

In step 306, the client application 28 flushes the history (e.g., any unsaved user history actions or events are encrypted and written to the user history file).

In step 308, the client application 28 shuts down. This removes the client application 28 from the client database system 14.

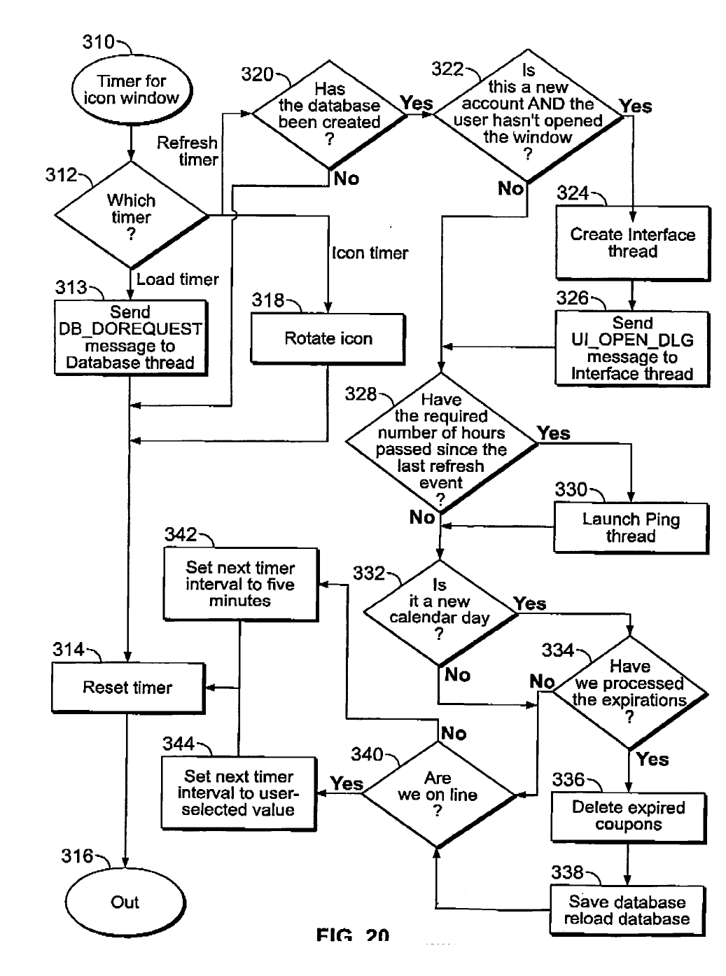

FIG. 20 is an exemplary flowchart diagram showing timing mechanisms for automatically updating coupon data without user intervention.

As shown, the exemplary flowchart illustrates the operation of three timers: the “load” timer, the “icon”, timer, and the “refresh” timer. The steps in FIG. 20 may hereafter be referred to as the timing loop thread. Step 310 marks the beginning of the processing for evaluating the various timing loops illustrated in FIG. 20.

In step 312, a decision is made by the client application 28 as to which timer is being evaluated. If the “load” timer is being evaluated in the timing loop thread illustrated in FIG. 20, then the process continues at step 313. In step 313, the timing loop thread sends a message to the database thread. In particular, the DB_DOREQUEST is the event the database thread uses to perform the delayed downloading. The client database system 14 feeds a DB_DOREQUEST event to the database thread while there are any coupons, plug-ins, or advertising impressions remaining to download. In response to this event, the database thread pops the top download request off the download queue and retrieves that item.

The process then proceeds to step 314, in which the “load” timer is reset. The process then proceeds to step 316, where the timing loop thread exits.

On the other hand, if the timer being evaluated is the “icon” timer, as determined in step 312, then the process proceeds to step 318. In step 318, the client application 28 rotates the taskbar icon 102. This is done only when there are new coupons or offers available to the user on the data distribution system 10. That is, this is the loop that causes the taskbar icon 102 to change display states so as to present a “flashing” effect to alert the user to the availability of new coupons and/or offers. The process then proceeds through steps 314-316, in which the “icon” timer is reset and the timing loop thread is terminated.

Finally, if the timer being evaluated in the timing loop thread is the “refresh” timer, as determined in step 312, then the process proceeds to step 320. In step 320, the timing loop determines whether a coupon database has been created. If the answer is “NO” then the process proceeds through steps 314-316, where the refresh timer is reset, and the timing loop is terminated.

On the other hand, if the answer to the inquiry in step 320 is “YES”, then the process proceeds to step 322. In step 322, if a user hasn't opened the user interface window containing the GUI 62 (FIG. 5A), and, the account is a new account, then the process proceeds to step 324, wherein the “create interface” thread is invoked to create the GUI 62 (best shown in FIG. 5A). The process then proceeds to step 326, where a user interface open dialog message is sent to the interface thread, which displays the GUI 62 in a window. The process then proceeds to step 328. If the answer to the inquiry in step 322 is “NO”, then the process proceeds to step 328.

In step 328, the timing loop determines whether the predetermined number of hours has passed since the last refresh event. In some implementations, the user may select, as described above, from a number of different refresh intervals (e.g., one-hour, two-hours, etc.). The value of this parameter is what is being tested in step 328. If theanswer to this inquiry is “YES”, then the process branches to step 330, where the echo-request/ping-the-net thread is invoked (FIG. 8). If the answer to step 328 is “NO”, then the process branches to step 332.

In step 332, the timing loop thread determines whether the present day is a new calendar day. This parameter needs to be tested because some coupons may now be “expired” that were not “expired” on the prior calendar day. If the answer to this inquiry is “YES”, then the process branches to step 334. In step 334, the timing loop thread determines whether the client application 28 has processed the coupon expirations arising because of the new calendar day. If the answer to this inquiry is “YES”, then the process branches to steps 336, and 338, where expired coupons are deleted from the database (memory), the database is saved (file), and the database is thereafter reloaded into the memory of the client application 28. The process proceeds to step 340.

If the answer to the inquiry in steps 332 or 334 is “NO” then the process branches to step 340. In step 340, the timing loop thread determines whether the client database system 14 is “online”. It may make this determination based on the response from the “ping” thread, invoked in step 330. If the answer to this inquiry is “NO”, then the process branches to step 342. In step 342, the next timer interval is set to five minutes (i.e., try again in five minutes to see if the user is “online”). In some implementations, the client application 28 will not force the user to connect to the network 16 to refresh the client database system 14, but will simply wait a predetermined time (e.g., five minutes) and check again to see if the user is connected.

Otherwise, if the answer to step 340 is “YES”, then the process branches to step 344, in which the next timer interval is set to the user-selected value (i.e., the one hour, two hour, etc. that the user chooses as the selected refresh interval).

The process then proceeds from both steps 342 and 344 to step 314 where the “refresh” timer is reset. The process exits in step 316.

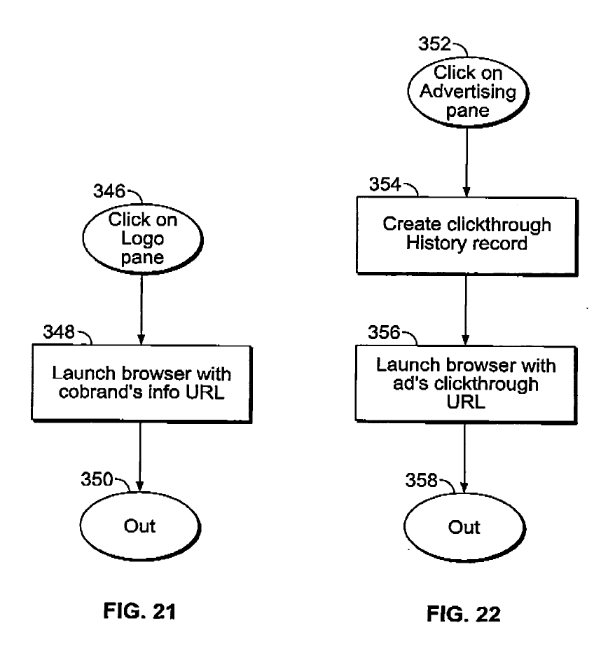

FIGS. 21-22 are simplified flowchart diagrams showing alternate actions taken by a client database system in response to selection by a user of a logo pane and an advertising pane, respectively.

Referring to FIG. 21, steps 346-350 illustrate the response of the client application 28 when a user “clicks” or otherwise selects the logo pane 74 of the GUI 62 (FIG. 5A). Step 346 marks the beginning of the routine. Step 346 is entered when the client application 28 (via an operating system) detects that the user has “clicked” on or otherwise selected a portion of logo pane 346.

In step 348, the client application 28 invokes an Internet browser registered with the operating system of the client database system 14 as the default browser and passes thereto a URL. The Internet browser then connects to a website server resource corresponding to the specified URL. This “click” action, therefore, takes the user to the website of the company displayed in the logo pane 74. Step 350 marks the end of this routine.

FIG. 22 shows a routine of a client application when a user “clicks” on or otherwise selects a portion of an advertising pane. Step 352 marks the beginning of the routine.

In step 354, the client application 28 creates a click-through history record indicative of the fact that the user has “clicked” or otherwise selected the advertiser displayed in the advertising pane 72. This will be included in the user history file 34, which will thereafter be encrypted and transmitted to the main database system 12 for processing.

In step 356, the client application 28 launches an Internet browser registered with the operating system of the client database system 14, and passes thereto a URL corresponding to the advertiser displayed in advertising pane 72. When the Internet browser executes, it connects to a website server resource defined by the URL. The foregoing actions take the user to the advertiser's website specified in the URL.

Step 358 marks the end of this routine.

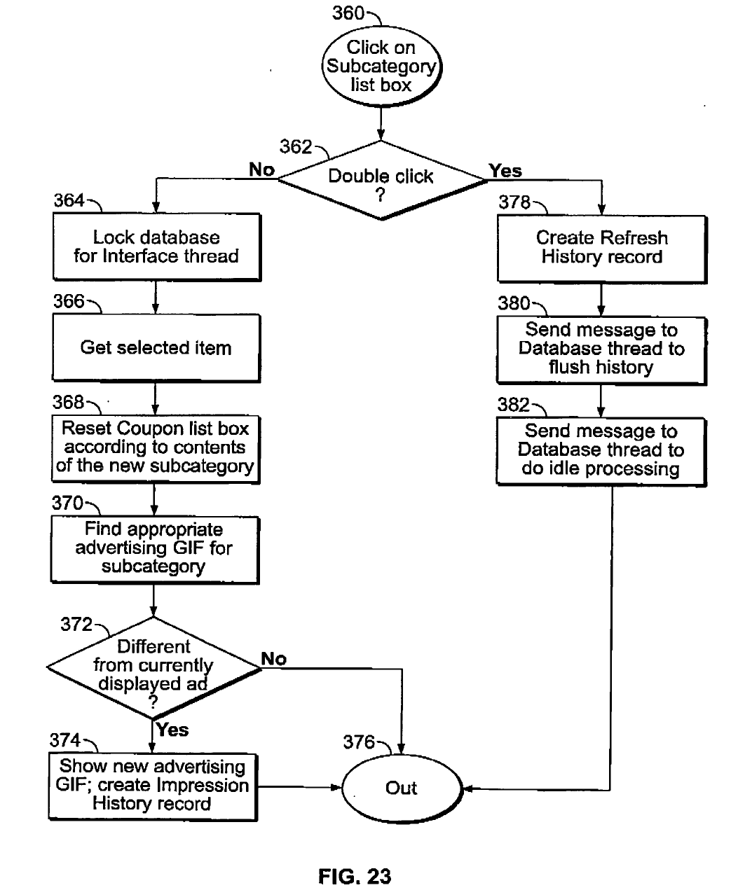

FIG. 23 is an exemplary flowchart diagram showing a process executed by a client database system when a user selects an item from a coupon subcategory list.

Referring to FIG. 23, step 360 marks the beginning of the process. Step 360 is entered when the client application 28 (via an operating system) determines that an item in the list 68 has been “clicked” on.

In step 362, the client application 28 determines whether the selection was a “click” or a “double-click”. Depending on which of these events occurred, the client application 28 will take alternative course of action. If the action is a single-click, then the process branches to step 364. In step 364, the local coupon database is locked by the client application 28. The process proceeds to step 366.

In step 366, the selected subcategory item is retrieved from the local database on the client database system 14.

In step 368, the contents of the coupon list 70 is reset by the client application 28 according to the contents of the new subcategory. For example, if the new subcategory pertains to coupons, then the new coupons associated with the new selected subcategory are displayed in the coupon list box 70 (FIG. 5A).

In step 370, the client application 28 determines or otherwise selects an advertising impression to be displayed in the advertising box 72 in accordance with a predetermined advertising impression selection strategy. As shown, the selection criteria includes the identity of the selected coupon subcategory.

In step 372, a test is performed by the client application 28 to determine whether the newly selected advertising impression is different from the advertising impression currently being displayed. If the answer is “YES”, then the process branches to step 374, where the new advertising impression is displayed in the advertising box 72, and an advertising impression history record is created for inclusion in the user history file 34. The process proceeds to step 376, which exits the thread as shown in FIG. 23. If the answer to step 372 is “NO” then the process branches to step 376, which is an exit step.

Alternatively, if the action evaluated in step 362 is determined to be a “double click”, then the process branches to step 378. “Double clicking” a coupon subcategory is a user request to refresh the contents of that subcategory.

In step 378, the client application 28 creates a refresh history event for that subcategory.

In step 380, the client application 28 sends to the database thread a request to flush the current history. The contents of that subcategory are then downloaded (available on the display 40) as if they were new.

In step 382, a message is sent to the database thread to do idle processing.

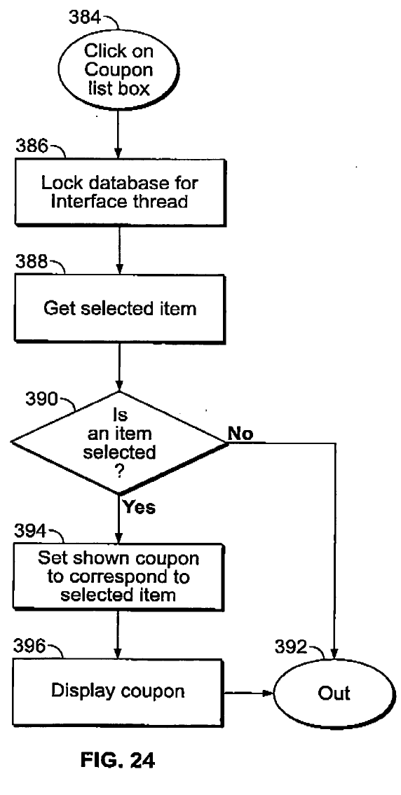

FIG. 24 is an exemplary flowchart diagram showing a process executed by a client database system when a user selects a particular coupon.

The process begins in step 384. Step 384 is entered when the client application 28 detects that an item in the coupon list box 70 (via an operating system) has been “clicked” on.

In step 386, the client application 28 locks the local coupon database for the interface thread.

In step 388, the client application 28 obtains from the local coupon database the item corresponding to that selected in coupon list box 70.

In step 390, the client application 28 determines whether the item in the coupon list box 70 that was clicked on was actually “selected”. If the answer to this inquiry is “NO”, then the process branches to step 392, which is an exit.

If the answer to step 390 is “YES”, then the process branches to step 394.

In step 394, the client application 28 sets the displayed coupon to correspond to the item selected in coupon list box 70. The process then proceeds to step 396.

In step 396, the client application 28, by way of the interface thread, displays the coupon in the coupon display pane 76. The process then proceeds to step 392, which is an exit step.

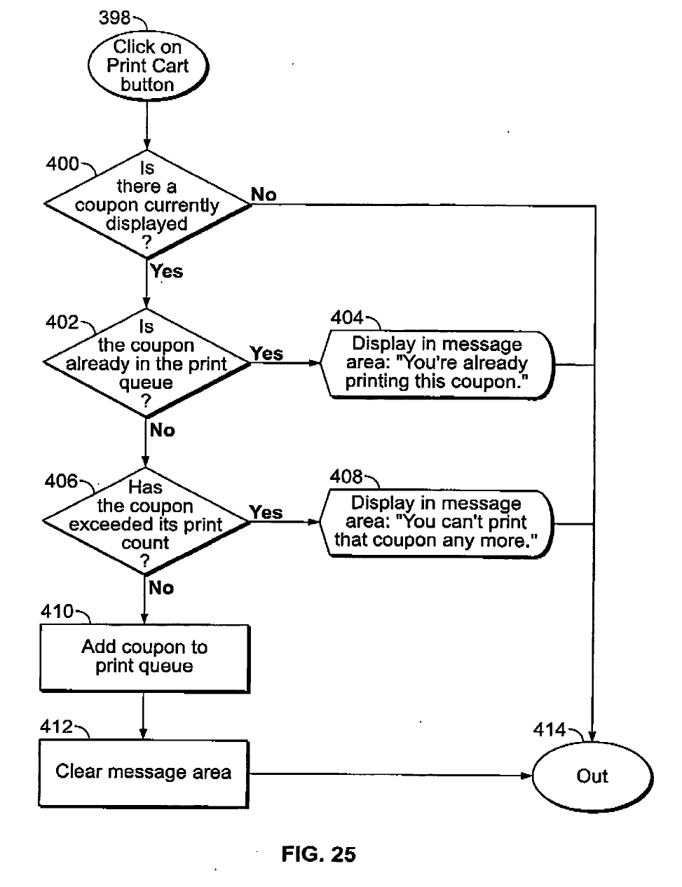

FIG. 25 is an exemplary flowchart diagram showing a process executed by a client database system when a coupon is selected and added to a print cart.

Referring to FIG. 25, step 398 is invoked when the client application 28 (VIA the OS) determines that the Print Cart button has been “clicked” on. The process then proceeds to step 400.

In step 400, the client application 28 performs a test to determine whether there is a coupon currently displayed in the coupon display pane 76. If the answer to step 400 is “NO”, then the process branches to step 414, which is an exit step.

If the answer to step 400 is “YES”, then the process branches to step 402. In step 402, the client application 28 determines whether the coupon currently being displayed in display pane 76 is already in the print queue. If the answer to this inquiry is “YES”, then the process branches to step 404. In step 404, the client application 28 causes a predetermined message to be displayed in message display area 94 advising, for example, the user that the coupon is already in the print queue ready for printing. This insures that coupons are not inadvertently printed more times than the user desires. If the user wishes to make multiple hard copies of the coupon in the display pane 76, the user may alternatively click on the “Print Now” button to print more than one hard-copy version of the coupon (if permitted by the rules or instructions associated with the coupon). The process then proceeds to step 414, which is an exit step.

If the answer to step 402 is “NO”, then the process branches to step 406. In step 406, the client application 28 determines whether the proposed printing of the coupon would exceed the associated maximum print count for that coupon. If the answer to this step is “YES”, then the process branches to step 408. In step 408, an appropriate message is displayed to the user in the message display area 94, advising that no further printouts of the coupon can be made. The process then proceeds to step 414, which is an exit step.

If the answer to step 406 is “NO”, then the process branches to step 410. In step 410, the coupon currently being displayed in the coupon display area 76 is added to the print queue. The process proceeds to step 412, where the message display area 94 is cleared, thereby clearing any pre-existing message displayed therein. The process then proceeds to step 414, which is an exit step.

### Hardware System Overview

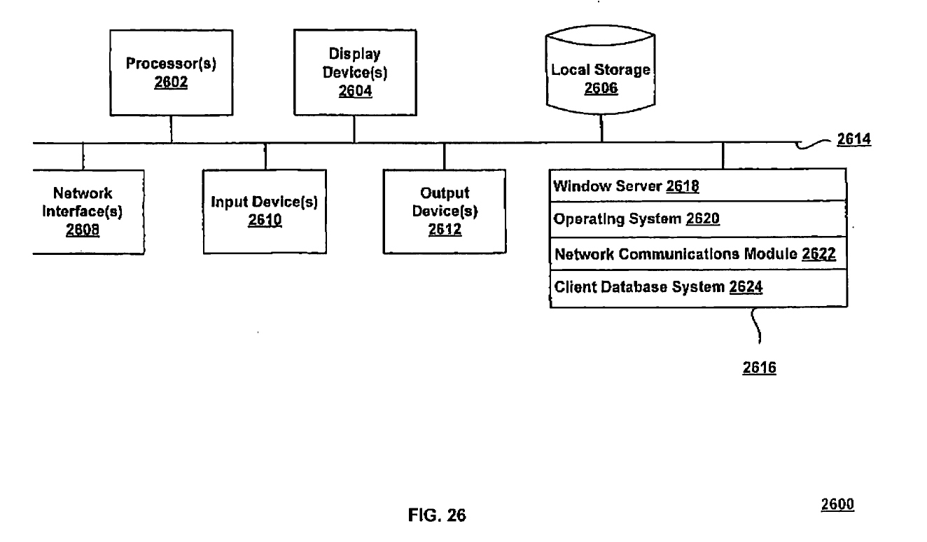

FIG. 26 is a block diagram illustrating a hardware system 2600 that supports a client database system. The hardware system 2600 shown can be implemented as a computing device including a desktop or portable computer, an electronic device, a telephone, a cellular telephone, a display system, a television, a monitor, a navigation system, a portable music device, a personal digital assistant, a handheld electronic device, an embedded electronic device or appliance or other forms of devices with user interfaces. The hardware system 2600 can be a standalone computer that can interface with other desktop computers, network computers and servers to access and exchange files or information that is not stored locally.

The hardware system 2600 can include one or more processors 2602 (e.g., IBM PowerPC®, Intel® Pentium IV, etc.) for executing program instructions embedded in the processors 2602 or other hardware components coupled to the processors through one or more buses 2614. The hardware system 2600 also can include one or more display devices 2604 (e.g., CRT, LCD) that can be part of or separate from the hardware system 2600. The hardware system 2600 further includes a local storage 2606 (e.g., computer hard disk) for storing program instructions, data or both, a network interface 2608 (e.g., Ethernet connection), input devices 2610 (e.g., keyboard, mouse, touch pad or stylus pen) to allow user input, output devices 2612 (e.g., a printer for printing “hardcopy” of a coupon) to provide information to the user, and one or more computer-readable mediums 2616. The computer-readable mediums 2616 can be one of a floppy disk or CD-ROM that may be used to transfer computer instructions or data to the processors 2602 or other hardware components for execution. Each of the hardware components described in the hardware system 2600 can exchange communications and data via the bus(es) 2614 (e.g., PCI, PCI Express, USB, FireWire™, NuBus™ and PDS).

In some implementations, if a keyboard is used as one of the input devices, the keyboard can be a physical QWERTY device, a phone dial pad, a keypad, mouse, jog wheel, joystick, game pad or other input device. In other implementations, the keyboard can be a virtual or soft key keyboard displayed on, for example, the display device 2604 or other touch screen device. In some implementations, the keyboard allows a user to input information with keystrokes which can be translated to electrical or data signals. Information provided by the input devices 2610 can be in the form of navigational, functional, textual or other input. Navigation information can be directional (e.g., up, down, left, or right). The keyboard also can provide other forms of input including functions (e.g., a selection function for selecting an object), text input and the like. Information can be provided by the user manipulating the input devices 2610. In some implementations, the processor(s) 2602 can generate and display information to the display device 2612 in response to user interactions received through the input devices 2610.

In some implementations, the computer-readable medium(s) 2616 refers to any medium that participates in providing instructions to the processor(s) 2602 for execution, including without limitation, non-volatile media (e.g., optical or magnetic disks), volatile media (e.g., memory) and transmission media. Transmission media includes, without limitation, coaxial cables, copper wire and fiber optics. Transmission media can also take the form of acoustic, light or radio frequency waves.

The computer-readable medium 2616 further includes a window server 2618 adapted to execute tasks (e.g., serving windows) on behalf of a user (or operating system), an operating system 2620 responsible for the direct control and management of hardware and software operations, a network communication module 2622 for providing data communication through one or more networks to other data devices that can use electrical, electromagnetic or optical signals and a client database system 2624 configured to provide interaction with a main database system for accessing electronic coupons.

The operating system 2620 can be multi-user, multiprocessing, multitasking, multithreading, real-time and the like. The operating system 2620 can be, for example, MAC OS® by Apple Computer, Inc. of Cupertino, Calif., a Microsoft Windows® operating system, Linux, a mobile operating system, control software, and the like. More generally, a kernel layer (not shown) in operating system 2620 can be responsible for general management of system resources and processing time. A core layer can provide a set of interfaces, programs and services for use by the kernel layer. A user interface layer can include APIs (Application Program Interfaces), services and programs to support user applications.

In some implementations, the operating system 2620, in coordination with the client database system 2624, displays one or more graphical user interfaces. A user interface may be understood to mean any hardware, software or combination of hardware and software that allows a user to interact with a computer system, and to include one or more user interface objects. User interface objects may include display regions, user activatable regions and the like.

The graphical user interface can display individual items including, for example, an icon, a shortcut, a program launcher, a button, a menu bar, navigation items, a window, selections and the like. Each item can provide access to functionality, applications, configuration of a user account, and data associated with a particular user.

Generally, the operating system 2620 can perform basic tasks, including, but not limited to: recognizing input from input devices 2610; sending output to display devices 2604; keeping track of files and directories on computer-readable mediums 2616 (e.g., memory or a storage device); and managing traffic on the bus 2614.

Various modifications may be made to the disclosed implementations and still be within the scope of the following claims.

What is claimed is:

1. A system comprising:
a client including a client application operable to provide information to a server including information that relates to a client user but does not specifically identify the client user;
the server including a dataset of coupons, the server selecting from the dataset appropriate coupons for distribution to the client from the dataset based on the information.

2. A method comprising:
identifying information related to a user of a system that is insufficient to specifically identify the user; and
using the information to select coupons from available coupons for distribution to the user.

3. A system, comprising:
means for collecting user information from a user of a client database system indicative of one or more demographic characteristics of the user without obtaining information sufficient to specify an identity of the user;
means for associating a user ID with the user information at a main database system;
means for selecting coupons according to the user ID to thereby identify coupons appropriate for the user based on the demographic characteristics; and
means for transmitting the selected coupons from the main database system to the client database system.
